(19) United States
(12) Patent Application Publication
(10) Pub. No.: US 2026/0339796 A1
(43) Pub. Date: Oct. 29, 2026

(54) ZERO DOWN-TIME ERROR CORRECTION FOR COHERENT DATACENTERS

(71) Applicant: Nvidia Corporation, Santa Clara, CA (US)

(72) Inventors: Ryan Albright, Beaverton, OR (US); William Andrew Mecham, Elk Grove, CA (US); William Ryan Weese, Portland, OR (US); Benjamin Goska, Portland, OR (US); Aaron Carkin, Hillsboro, OR (US); Jordan Levy, Portland, OR (US); Siddha Ganju, San Jose, CA (US); Scott Millward, San Jose, CA (US); Elad Mentovich, Tel Aviv (IL)

(21) Appl. No.: 19/193,635

(22) Filed: Apr. 29, 2025

(51) Int. Cl. G06F 11/20; G06F 11/07; G06F 15/173

(52) U.S. Cl. CPC G06F 11/2028; G06F 11/0709; G06F 11/0793; G06F 15/17343

(57) ABSTRACT

Approaches presented herein provide for the dynamic and intelligent management of issues, such as memory or link errors, identified during execution of large processing jobs performed using a number of computing resources. A number of processing units can be logically interconnected to function as a single large processing unit, with a unified memory address space and interface structure as part of a coherent fabric. When an error is detected in an individual processing unit or link, for example, a determination can be made as to the scope of the error, and an attempt can be made to contain the error to allow performance of the job to continue uninterrupted using the remaining resources of the fabric. This may include determining a resource or section of memory to be masked off from further usage, then automatically remapping the address space or otherwise updating information for the coherent fabric to allow for continued operation. If necessary, an impacted portion of the job can be re-run after the adjustment while allowing other portions to continue processing.

### TECHNICAL FIELD

This disclosure relates to the performance of jobs in a complex computing environment, and in at least one embodiment relates to the uninterrupted performance of large computing jobs performed in a datacenter in the event of a detected or predicted error in one or more datacenter resources.

### BACKGROUND

As an increasing amount and variety of complex operations are being performed on increasingly large and varied datasets, computing environments such as datacenters and server farms are also becoming increasingly complex. Large server-based systems are being connected together in ways that allow for the sharing of a single, large memory footprint, which can help to support long-running and complex jobs, such as may relate to training or generating inferences using large artificial intelligence (AI) models. A downside to such an approach, however, is that an error in as little as a single processing unit, section or memory, or communication link can cause issues with the shared memory space and coherent set of resources, and can result in a need to reperform a significant amount of processing. Such reperformance can be very time consuming and costly from at least a resource and compute perspective. For jobs that may take weeks to run and that consume a vast amount of power and resource capacity, an error that can invalidate an entire workload can come with an excessive amount of expense and delay. Further, the need to perform manual intervention, as in many prior approaches, introduces yet additional time and expense, and introduces the possibility of human error.

### BRIEF DESCRIPTION OF THE DRAWINGS

Various embodiments in accordance with the present disclosure will be described with reference to the drawings, in which:

FIG. 1A illustrates an example datacenter system architecture in which aspects of various embodiments can be implemented, according to at least one embodiment.

FIG. 1B illustrates an example layout of components in a datacenter, according to at least one embodiment.

FIG. 2A illustrates an example computing device that can be used as part of a coherent fabric, according to at least one embodiment.

FIG. 2B illustrates an example implementation of a chip-to-chip (C2C) interface, according to at least one embodiment.

FIG. 3A illustrates an example high speed link map that can support a dynamic and coherent fabric, according to at least one embodiment.

FIG. 3B illustrates an example system topology that can be used to provide a coherent fabric, according to at least one embodiment.

FIG. 4A illustrates an example process that can be performed to detect and account for errors in real-time during performance of a job, according to at least one embodiment.

FIG. 4B illustrates an example process that can be performed to identify a level at which an error can be contained in a coherent fabric, according to at least one embodiment.

FIG. 5 illustrates an example datacenter system, according to at least one embodiment.

FIG. 6 is a block diagram illustrating a computer system, according to at least one embodiment.

FIG. 7 is a block diagram illustrating a computer system, according to at least one embodiment.

FIG. 8 illustrates components of an example computing system, according to one or more embodiments.

FIG. 9 illustrates an example enterprise AI system that can be used to perform aspects of one or more embodiments.

FIG. 10 is an example data flow diagram for an advanced computing pipeline, in accordance with at least one embodiment.

FIG. 11 is a system diagram for an example system for training, adapting, instantiating and deploying machine learning models in an advanced computing pipeline, in accordance with at least one embodiment.

FIGS. 12A and 12B illustrate a data flow diagram for a process to train a machine learning model, as well as client-server architecture to enhance annotation tools with pre-trained annotation models, in accordance with at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

Approaches in accordance with various illustrative embodiments can provide for dynamic and intelligent management of issues, such as memory or link errors, that may be identified during the execution of large processing jobs performed using a number of computing resources. A number of processing units can be logically interconnected to function as a single large processing unit, with a unified memory address space and interface structure as part of a coherent fabric. This coherent set of resources may be used to perform very large and long-running jobs, as may relate to the training of AI models, which can be very costly if a job needs to be restarted as the result of an error. At least one approach disclosed herein can detect such an error, or predict a future such error, during the performance of a job and can determine the scope of the error-such as whether the error impacts a portion of the memory of a processing unit (e.g., a graphics processing unit (GPU)), an entire GPU, a communications link, or a rack or cluster of processing units, among other such resources. Once the scope is determined (and assuming the scope does not exceed a reasonable amount needed to perform the job), that portion of the coherent fabric (e.g., a portion of address space, a GPU, or other subset of resources) can be removed or masked from use or consideration for performing the job. The fabric can be also adjusted by dynamically remapping the address space, available links or systems, and other such aspects. Such dynamic removal and remapping during performance of an active job can allow performance of the job to continue without interruption, other than a slight introduction of latency to perform the remapping and transfer any data as a result of the remapping in at least one embodiment.

A system manager (such as may include a job manager, resource manager, and/or fabric manager, for example) can insert checkpoints at various points in the performance of the job, as may be determined based in part upon telemetry data. If an error has resulted in a portion of the job (e.g., a discrete task) being performed unreliably, incompletely, or not at all, for example, then that portion of the job may be restarted from the checkpoint, potentially using one or more alternate resources, without impacting other portions of the job. Such an approach can help to reduce the need to reperform portions of the job, and limit the scope of any such reperformance. In at least one embodiment, communication links used for such purposes may include high speed links with the ability to use atomic structures and variables with a unified memory map interface.

Variations of this and other such functionality can be used as well within the scope of the various embodiments as would be apparent to one of ordinary skill in the art in light of the teachings and suggestions contained herein.

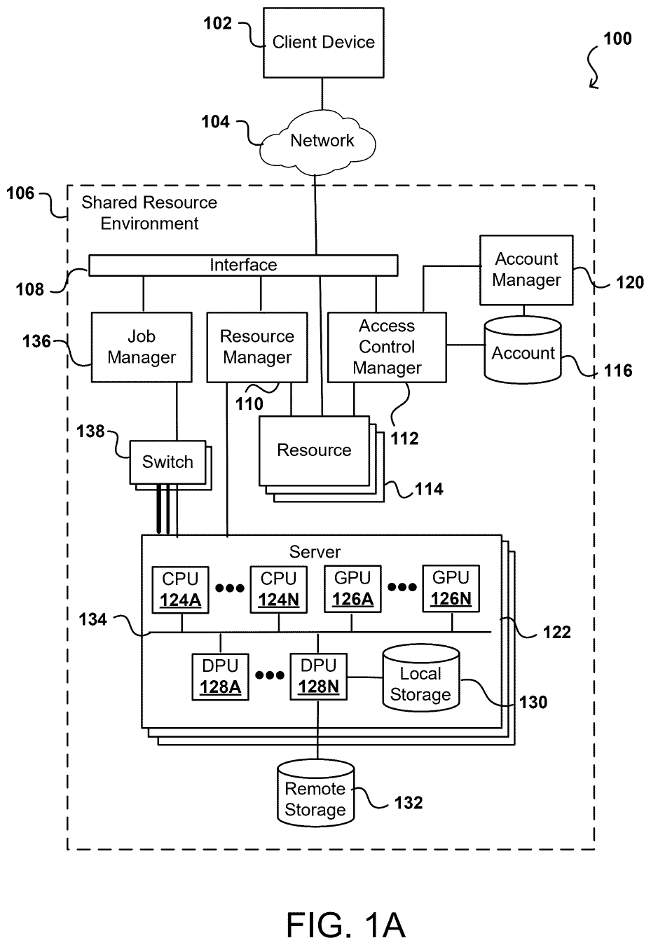

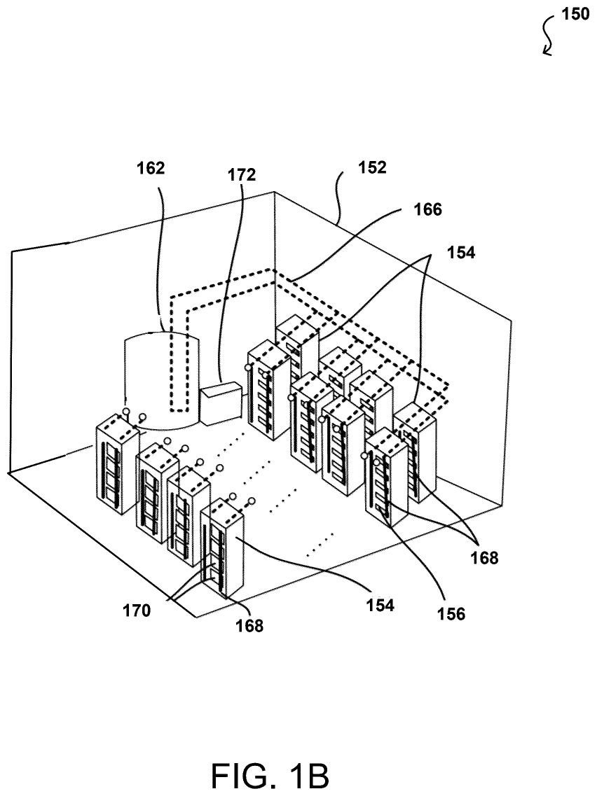

As mentioned, complex computing environments such as datacenters can be used to perform various computing operations on behalf of one or more entities, such as by using a pool of available resource capacity. FIG. 1A illustrates an example architecture 100 that can be used to provide such capacity and perform such computing operations. In this example, a user is able to use a client device 102 to submit one or more requests to access one or more resources, or to perform a task using one or more resources, among other such options. Such a request can be submitted over at least one network 104, such as the Internet or a cellular network, and received to an interface, address, or endpoint in a shared resource environment 106. The request can be received to an interface, such as an application programming interface (API) of an interface layer 108, for example, which may include other networking devices as well, as may include routers, network switches (e.g., an NV-Switch or Spectrum-X switch), load balancers, and the like. In this example, a request from a client device 102 may first need to be analyzed to determine whether the client device, user, or other entity associated with the request has access to one or more resources to be used to process the request, as well as to determine whether the type of access permitted allows for performance of the requested operation.

In this example, information for the request can be directed to an access control manager 112, or other such component, system, or service. The access control manager 112 can perform various tasks to determine and/or manage access to a set of shared resources 114, such as to extract relevant information from a received request and compare, by an account manager 120 or other such system or service, information for the request against information in an account repository 116 or other such location. If it is determined that the request is associated with a valid account, that account information can be used to determine the type of access permissible to perform one or more operations associated with the request. In some embodiments, an access control manager 112 may work with a resource manager 110 to determine a specific instance of a type of resource 114 to be used to perform an operation with respect to the request, whereas the resource manager 110 can perform other types of operations as needed, such as to allocate additional capacity of a type of resource, launch a new compute instance, or perform another such task associated with the request.

In many instances, a request that involves a number of operations to be performed may have those operations, or portions of those operations, distributed across a set of processing resources. This may include distribution across a number of physical compute resources, such as a set of shared servers, and/or may include multiple processing resources (physical or virtual) within a given physical resource. As an example, FIG. 1A illustrates example components that may be found within a given server 122 that may be allocated to perform one or more processing tasks with respect to a request. The server 122, in this instance, is illustrated to contain different types of processing units, including one or more central processing units (CPUs) 124A-124N, one or more graphics processing units (GPUs) 126A-126N, and one or more data processing units 128A-128N, as may be interconnected using at least one internal bus 134. At least the DPUs 128A-128N in this example may be connected to local storage 130 in the server, as well as at least one remote storage instance 132 that may be external to the server but within the shared resource environment 106. CPUs 124A-124N are often used for tasks such as single threaded user applications, and GPUs 126A-126N are often used to perform multiple small but related operations in parallel. DPUs can be used to offload processing tasks from these CPUs and GPUs that may not optimally be performed on these processing units, as may related to heterogeneous data-centric processing tasks that can benefit from a different type of accelerated processing. A DPU is a programmable processor or system-on-chip, which combines one or more multi-core, high-performance CPUs, a set of acceleration engines that can offload and improve performance for data-centric tasks, and one or more high-performance interfaces capable of parsing, processing, and efficiently transferring data at high speeds. A DPU can be used as a stand-alone embedded processor, or can be incorporated into a smart network interface card (SmartNIC) in a server, among other such options.

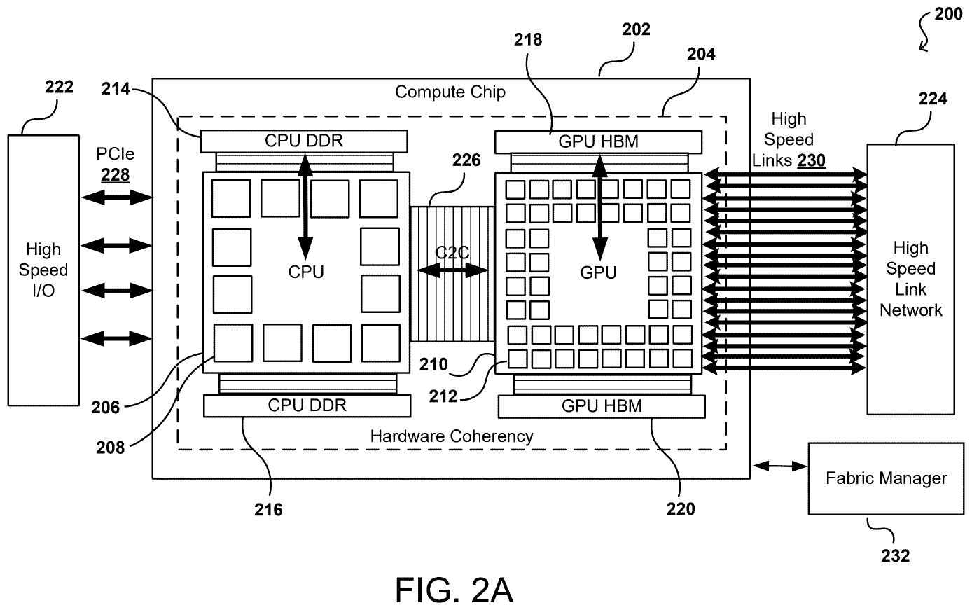

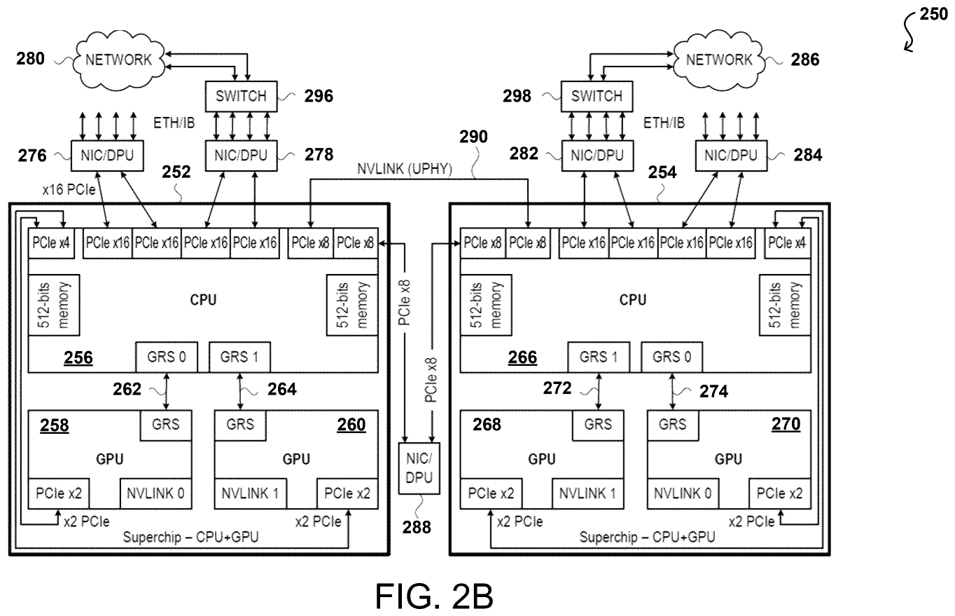

In at least one embodiment, a job manager 136 can be used to manage the performance of various jobs using at least some of the resources 114 allocated by the resource manager 110. These resources may include various servers 122 and switches 138, which may include various processing units connected by a variety of communication links. As discussed in more detail later herein, a job manager 136 can work with a resource manager 110 to dynamically scale and adjust resources as needed to continue processing a job without interruption. In situations where a fabric manager (such as the fabric manager 232 discussed with respect to FIG. 2) is also used to manage a coherent fabric composed of these resources, which can function as a single resource with a single interface and memory space, the job manager 136 can work with the fabric manager to ensure that the fabric is able to support the job with at least a minimum level of performance, as may require adjustment of the fabric and its component resources in at least some embodiments.

In at least one embodiment, a datacenter 150 in FIG. 1B may include one or more rooms 152 having racks 154 and auxiliary equipment to house one or more servers 170 on one or more server trays, as well as graphics processing units (GPUs) 156 and other such components. In at least one embodiment, a datacenter 150 can be supported by a cooling tower located external to the datacenter 150. A cooling tower can dissipate heat from within a datacenter 150 by acting on a primary cooling loop 166. In at least one embodiment, a cooling distribution unit (CDU) 162 is used between a primary cooling loop 166 and a secondary cooling loop, or other such heat removal mechanism. There may be cooling manifolds 168 used for individual server racks, for example, and a heat exchanger 172 or other temperature management system used to provide additional cooling and/or temperature management. Proper maintenance of such a datacenter involves not only maintenance of the computing resources, but also components and systems related to networking, power, cooling, and other such aspects. In many instances, maintenance of any one of these types of devices or systems may involve modification, at least temporarily, of one or more of these other types of devices or systems.

As mentioned, such datacenters are becoming increasingly more sophisticated and complex, including an increasing number of server systems that may be connected together to allow for sharing of a single, larger memory space. Such a system may include a “fully coherent” fabric of interconnected resources, where all memory in the system can be made accessible, with minimal latency, by all performant computation devices (e.g., CPUs, GPUS, DPUs, and other such processing elements) in the system that require access. Because the fabric is fully coherent, all computing devices that are part of the fabric can perceive a change in real-time, from their contextual perspective, when one of the computing devices accesses a region of memory.

FIG. 2 illustrates an example implementation 200 of a “compute chip” type device that can be utilized in a datacenter or other complex computing environment, in at least one embodiment. As illustrated, such a device can include multiple processors, such as at least one CPU 206 (with multiple CPU cores 208) and at least one GPU 210 (with multiple GPU cores 212), with multiple link types that can all be used concurrently. Such a device, or compute chip 200, may include multiple compute “die,” which may be connected through at least one “die-to-die” connection, such as a high bandwidth interface (HBI). If there are multiple such compute chips, each individual compute chip may have a connection to a one or more other chips through at least one “chip to chip” interface 226. Each of these chips may also have connections to local cache, on chip memory (e.g., HBM or DDR) 214, 216, 218, 220, or off chip memory (e.g., a DIMM, LPCAMM, or other such memory module). Each chip may also have other interfaces, such as PCIe interfaces 228 for network based storage or high speed I/O 222, or local to server storage (e.g., U.2/M.2/SSDs). There may also be one or more high speed links 230 with the ability to use atomic structures and variables and a unified memory map interface, such as NVLinks from NVIDIA Corporation, which can specifically allow for incredibly fast links between a combination of, for example, switch devices and GPUs. Servers that may include such chips are also getting increasingly complex themselves. In one example system, a server includes 72 GPUs, 18 high speed switches, and up to 36 DPUs. There is also the capacity to have the high speed links scale up a level through high speed switches that connect to other racks, scaling up further. A set of resources used to perform a complex processing job may utilize several such chips, and/or other processing devices, connected using a set of high speed links, switches, and other such components.

A fabric manager 232, or similar such component or system, can be used to help ensure a region of hardware coherency 204 at least at the level of the chip 202 or board. In at least one embodiment, a fabric manager 232 can be a secondary driver that runs on a high speed link domain (e.g., an NVLink domain), and can work with a primary driver and/or resource manager 110. A fabric manager 232 can manage the resources comprising the coherent fabric to ensure that a given workload or compute job can continue to run, or be processed. In at least one embodiment, a fabric manager 232 (and/or job manager 136) can attempt to ensure that such a job continues to be processed, even if the resources of the coherent fabric are forced to operate in a degraded mode of operation. In some instances, however, there may be a minimum amount of degradation or reduced operation that is allowable before a job should be terminated or other such action is taken. The fabric manager 232 can dynamically modify its own behavior to account for such reduced or modified operation, without losing state of an active job. A fabric manager 232 can work with a resource manager (which may take the form of a DPU driver in at least one embodiment) to attempt to modify the resources allocated to a given cluster, for example. The fabric manager can also take advantage of other drivers that talk to other relevant devices as well. A resource manager might also detect errors or issues that may not have been detected by the fabric manager 232, and can provide relevant information to the fabric manager 232 that can be used to dynamically adjust or modify the relevant resources of the fabric.

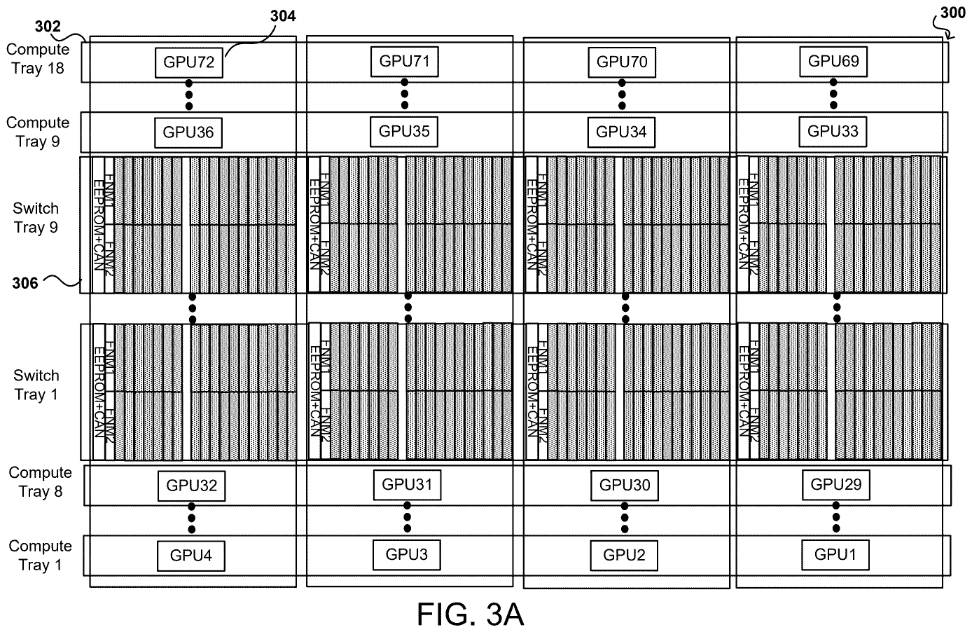

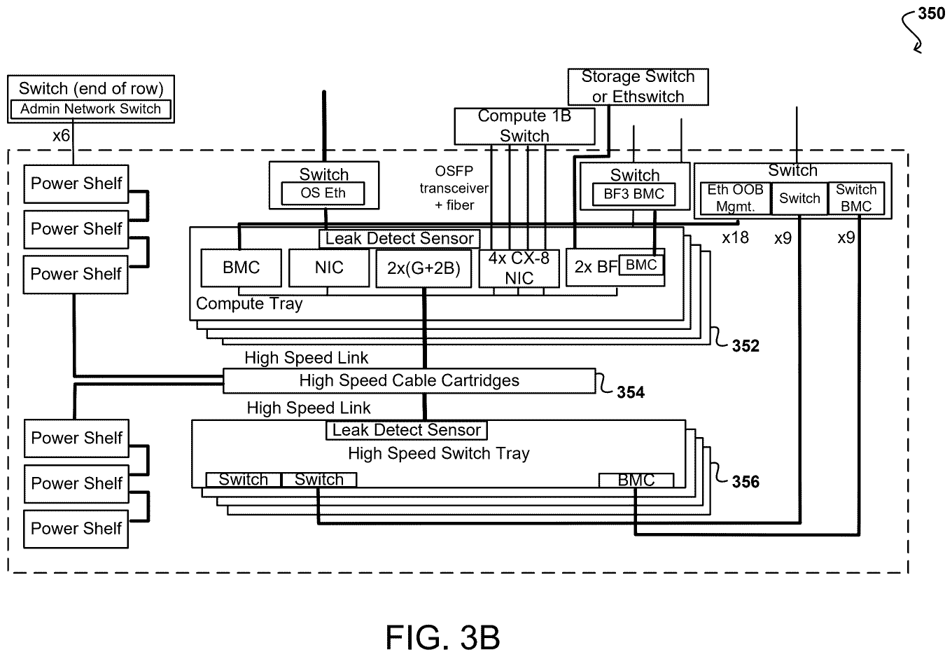

Such a fabric manager 232 can account not only for links between the components on the chip 202, but also errors over high speed links 230 to offline switches and other components of a high speed link network 224, as well as links to various external memories and other such components (as also illustrated in FIG. 3B). In addition, a fabric manager 232 can also have to monitor the status or health of various memories, such as HBM memory 218, 220 or DDR memory 214, 216, as well as other memories that may be on, or off, a given chip 202, as well as memory in the CPU 206 or GPU 210 and other such locations.

FIG. 2B schematically illustrates a computing system 250, e.g., a data center or a High-Performance Computing (HPC) cluster, in accordance with at least one embodiment. This example computing system 250 comprises a plurality of subsystems, as may include multiple processing devices coupled to each other using various interfaces, as well as multiple network devices, and multiple networks, according to at least one embodiment. This example computing system 250 is designed with multiple integrated circuits (referred to as processing devices), where each integrated circuit can include one or more CPUs and GPUs, forming a powerful and flexible architecture.

The various processing devices illustrated in FIG. 2B are interconnected via an NVLink or other high-speed interconnect, enabling high-speed communication between the subsystems, and are also connected through a NIC or DPU to ensure efficient data transfer across the computing system 250 and to one or more external networks 280, 286. In the present example system computing 250, a packet switch 296 connects a NIC/DPU 288 to a first network 280, and a packet switch 298 that connects a NIC/DPU 282 to a second network 286. The coupling of processing devices through a communication channel such as NVLink allows for seamless data exchange and parallel processing, enhancing overall computational performance. The processing devices are connected to multiple networks through one or more network interface cards (NICs) or DPUs, enabling the system to handle complex, multi-network tasks with high bandwidth and low latency. This configuration is highly suitable for demanding applications that require significant processing power, such as artificial intelligence (AI), machine learning (ML), and data-intensive computing, while ensuring robust connectivity and scalability across various networked environments. The integrated circuits of the computing system 250 can include one or more CPUs and one or more GPUs.

FIG. 2A also illustrates an example architecture of a multi-GPU architecture. As illustrated in the figure, the example computing system 250 includes a processing device 252 with a multi-GPU architecture. In particular, the processing device 252 may be a system-on-chip (SoC) and include multiple subsystems such as a CPU 256, a GPU 258, and another GPU 260. This CPU 256 can be coupled to one GPU 258 via a die-to-die (D2D) or chip-to-chip (C2C) interconnect 262, such as a Ground-Referenced Signaling interconnect (GRS interconnect). The CPU 256 can be coupled to another GPU 260 via a D2D or C2C interconnect 264 as well. This CPU 256 can also couple to these GPUs 258, 260 via PCIe interconnects.

This CPU 256 can be coupled to one or more NICs or DPUs, which an in turn be coupled to one or more networks. For example, as illustrated in FIG. 2B, this CPU 256 is coupled to a first NIC/DPU 276, which is coupled to a network 280. This CPU 256 is also coupled to a second NIC/DPU 278, which is coupled to a network 280 via a switch 296. A first NIC/DPU 286 and a second NIC/DPU 278 can be coupled to this network 280 over Ethernet (ETH), NVLink or InfiniBand (IB) connections, as examples.

The example computing system 250 also includes a processing device 254 with a multi-GPU architecture. In particular, this processing device 254 includes multiple subsystems including a CPU 266, a GPU 268, and a GPU 270. This CPU 266 can be coupled to a first GPU 268 via an D2D or C2C interconnect 272. This CPU 266 can also be coupled to a second GPU 270 via a D2D or C2C interconnect 274. The CPU 266 can also couple to these GPUs 268, 270 via PCIe interconnects. A CPU 266 can be coupled to one or more NICs or DPUs, which are coupled to one or more networks. For example, as illustrated in FIG. 3B, a CPU 266 is coupled to a first NIC/DPU 282, which is coupled to a network 286. This CPU 266 is also coupled to a second NIC/DPU 284, which is coupled to a network 286 via a switch 298. These NIC/DPU devices 282, 284 can be coupled to a network 1036 over Ethernet (ETH), NVLink or InfiniBand (IB) connections, among other such options.

In at least one embodiment, a first processing device 252 and a second processing device 254 can communication with each other via a NIC/DPU 288, such as over PCIe interconnects. The processing devices 252, 254 can also communicate with each other over a high-bandwidth communication interconnect 290, such as an NVLink interconnect or other high-speed interconnect. The packet switches in FIG. 2B may comprise, for example, NVIDIA Quantum-2 switches. The NICs/DPUs in FIG. 2B may comprise, for example, NVIDIA Bluefield DPUs.

Approaches in accordance with various embodiments can attempt to isolate, correct, and/or continue with confident, uncorrupted data in any memory in such massive, fully coherent systems. In at least one embodiment, a job manager (such as job manager 136 in FIG. 1A) can be used to manage the performance of various tasks in accordance with at least one embodiment. Such a job manager can contain various modules or processes that can be used to help ensure operation of various compute resources with zero downtime. For example, an error containment module can be used to automatically identify and isolate “bad” sectors of memory, or sectors that have been determined to be at least unreliable to use for data storage. On certain datacenter-class GPUs (e.g., NVIDIA A100 and H100), for example, uncorrectable Error-Correcting Code (ECC) errors on GPU applications can limit the impact of a memory error to the application that encountered the error. A masking module can be used to identify (or receive identification of) sections of a die that are less performant, typically at the boundaries of the physical, and mask off those areas mask off areas of memory from further use. A dynamic page offlining module (or driver, etc.) can be used to identify the location of an uncorrectable error in a frame buffer memory, and can mark the page containing the error as unusable. Once the page is marked unusable, any of the currently-executing or newly-launched workloads will not allocate the marked page. A row remapping module or process can be used to prevent known degraded memory locations from being used. If certain memory areas are throwing errors, those areas can be effectively removed by remapping the rest of memory to not expose the affected rows to the application layer. A row-remapping module can logically replace degrading memory cells with spare memory cells to avoid offlining regions of memory in software.

In such an implementation, a memory controller can, any time a known-bad address is accessed, direct that access to a new, remapped location in a part of the same bank allocated for spares. Such a system can attempt to implement, for clusters of processing units, mechanisms used successfully for single processing units. In clusters of processing units, there will typically be a “fabric” of systems running applications through a “fabric manager” for these and other such critical links. The modules described above as part of this example system can be used at a full cluster scale, while also adding new mechanisms. For example, if a single GPU has a memory link slow down, such as where a high speed link or a chip-to-chip link is not performant, the GPU may be removed, masked off, or taken offline from the cluster to avoid issues such as “weakest link” slowdowns of the full system. The same (or a similar) mechanism can be applied to a server tray in a cluster of server trays, a server rack in a cluster of server racks (such as in an L2/L3 domain), or a pod of server racks in a datacenter of compute pods (or other such groupings). In such an approach, mechanisms similar to those that were previously used at a memory/chip level can be applied at the system level to a system with fully coherent memory. In such an approach, however, prior single chip memory interfaces will not suffice, and interfaces and configurations as disclosed and suggested herein can be used to allow such processes to be used for a scope that includes an entire datacenter of coherent memory devices including, without limitation, DPUs, GPUs, and CPUs.

Such an approach can allow a cluster (or other interconnected group) of GPUs (or other such processing units) of any size to function as a single processing unit. This can include groupings of processing units that may include some or all of the processing units in an entire datacenter and beyond. As mentioned, these processing units can be connected in various ways, such as by being packaged on the same boards or chips, or being connected through switches and fabric management. This may include the use of chip-to-chip (C2C) interfaces and/or shared connections to high bandwidth memory. Independent of the form, these processing units can all be configured to work together to process large compute jobs. Processing units of different types can also be interconnected, such as by connecting GPUs to CPUs, with at least some of the differences being abstracted into the fabric. The boards can be integrated into server trays (or compute trays), which can be connected to a backplane, for example, or connected through a direct NIC fabric management, such as by using InfiniBand or other such connections. In some embodiments, GPUs can communicate through one or more NICs and at least one DPU, among other such options. Such a system can thus be quite complicated from at least an architecture standpoint, particularly when scaled up to the size of an effectively building-scale GPU or other such processor.

FIG. 3A illustrates an example high speed link map 300 that can support a dynamic and coherent fabric, according to at least one embodiment. In this example map 300, there are a number of processing units (here GPUs 304) contained in a number of compute trays 302. There are also a number of switch trays 306 that include memory and address (map) information for the various GPUs. Such an approach can allow for any of these GPUs to work together as a single processing unit, with the address space allocated accordingly. For any changes in the memory space, such as masking off of various sections of memory, the mappings can be updated automatically, and data routed according to the current mappings. Each switch tray can include one or more high speed switches, such as NVLink switches, that are controllable as discussed herein.

FIG. 3B illustrates another view 350 of a configuration of resources that can be used to provide a coherent fabric according to at least one embodiment. As illustrated, there are a number of compute trays 352 that each include a number of processing units and interfaces (e.g., BMC, NIC, or other such interfaces) that allow for links of different types, capacity, and speeds to be used to communicate with other components. There are also a number of high speed switch trays 356, each including one or more high speed switches (e.g., BMC, ComExpress, or other such switches), which can communicate with the server trays using a high speed link and via at least one high speed cable cartridge 354. As illustrated, these components can communicate with each other, as well as external components, using a number of different switches of different types, including high speed switches as discussed herein. A coherent fabric or group of resources can support all of these types of links and components, to allow these components to function as a single logical unit with a single address space and primary interface. A fabric manager and resource manager can work together to monitor the state of the various components, identify any actual or potential errors, make one or more appropriate and intelligently-determined adjustments to account for the errors, and allow a job to continue without interruption.

It can be of particular importance to properly define error correction in systems with such high levels of complexity. It can also be beneficial to allow such a system to continue to effectively run with one or more errors to keep processing a large job, even if a portion of this large and complex system is not fully healthy, at least in the way in which healthy has been defined for the system. For example, there may be an error in memory or a processing unit, and it can be important to determine how to best retain and utilize those sections of memory that are useful, while masking out those sections of memory that may no longer be useful. A job manager or similar such component can then attempt to determine how to best continue running a job using the resources and memory that are still available for this cluster or group of computing resources. Without such error correction mechanisms, it is possible that as little as a single unhealthy compute resource, or “node,” could effectively take down the entire cluster or system. As mentioned, for long running jobs that may consume a significant amount (e.g., many gigawatts) of power and compute capacity, it can be important to avoid having to restart even portions of a job, not only from a power and cost standpoint, but also from a service level standpoint where other jobs in a job queue may then have to wait an unacceptable amount of time before resources become available to perform those jobs. It can be desirable in at least some embodiments to ensure that a complex computing environment can continue to operate with zero downtime, even in the case of errors or unavailable resources. This can be particularly important for datacenters that may have hundreds of thousands of processors (or more) working together, where there is a high probability of intermittent device failures, and other such errors, over time. It can also be important in at least some embodiments to determine the level at which a failure can be contained, in order to attempt to mask off as little of the resource footprint as possible. For example, an error might be able to be contained at the level of a compute cluster, GPU, rack, system, or compute pod (or other such grouping), and identifying the lowest level at which an error can be contained can help to ensure that a minimum portion of a job or workload may need to be rerun as a result of the error.

In one example of an error for which correction can be performed, a single GPU might have a communication link slowdown or memory error. For a memory error, the GPU may no longer be able to handle matrices of a given size because there are too many sections of memory that are now determined to be inefficient. The GPU can then be tasked with processing smaller chunks of the job, or can be removed from the coherent fabric completely if determined to be too inefficient, among other such options. Such a decision might be made by a resource manager or higher-level component. A decision may be made to mask out the GPU from the fabric (or cluster, etc.) so that the GPU can be ignored for purposes of processing at least the current job.

The fabric or cluster can then be scaled as appropriate to account for the loss of the GPU, and the memory remapped so that the healthy sections of memory can be used. If the error is in GPU memory, it would be possible in at least some embodiments for the bad sectors of memory to be masked off and the memory remapped, and the GPU allowed to continue processing the job with the remaining memory sectors. In another example, a given job may have bandwidth limitations that are not necessarily related to memory size and are more related to total compute power for smaller chunks. In this case, the GPU may continue to be used but the jobs rescaled or reapportions among the available GPUs to still get the necessary bandwidth among the target number or selection of GPUs. The given chunks can also be resized in at least some embodiments.

As mentioned, such a process can be implemented at various levels, such as for a single server, server tray, or group of server trays, based in part upon the way in which compute clusters are organized. This can include using connections such as C2C, NVLink, Infiniband or other such connections, which provide at least some amount of control. This allows a resource manager and fabric manager to work together to define a “processing unit” for a given fabric, which may, in fact, be made up of multiple individual processing units, links, and other such components. Such definition can be also used or expanded as appropriate as the system scales so it can be located and used by the fabric manager. There may be two GPUs on a board and a fabric manager can locate the GPU through a controllable high speed link, such as NVLink, and the high speed link can allow that GPU to communicate with other relevant devices, such as may be in other trays or racks, etc., as may be accessible through various controllable network switches that support those types of high speed links. This may include top of rack switches that allow for scaling beyond multiple racks into a pod, cluster, or other such grouping. Regardless of the size or form, a resource manager and fabric manager can work together to allow these and other such components to provide a coherent ecosystem.

A resource manager can attempt to monitor resources and provide an updated indication of available resource capacity at any time. A fabric manager can work with the resource manager to adjust a compute cluster based in part upon the capacity that is determined to be available at any given time. If a cluster is abstracted out to a pod level, there may be one pod where all the racks are healthy and another pod that has two unhealthy racks. A current job may be processed under the assumption that there is a balance over those two pods, but the processing may need to be adjusted to represent the actual differences in currently available capacity. In some embodiments, instead of attempting to perform and manage asymmetric compute across these two pods, a portion of the processing may be moved to another pod with all healthy racks so that the job can be run more smoothly and efficiently. If possible, the pod with the healthy racks could also be downsized to have two fewer racks included, so that a balanced compute could still be performed but using fewer total racks.

As mentioned, a significant benefit of error correction, dynamic resizing, and other such tasks disclosed herein is that they can be performed at runtime, and without interrupting the processing of a job running on the corresponding resources. Such functionality has not been provided previously in large part because an error on a single processor may not be significant in many cases because a job can be relaunched on a new GPU without significant delay. Such a job may not require an excessive amount of total memory, and such relaunching may not result in significant additional latency. For large, complicated processing jobs, such as those related to training or performing inferencing using an AI model, on the other hand, the need to relaunch a job can come with significant extra time and cost, which may be unacceptable (or at least highly undesirable) in at least some instances. Another benefit to the approaches disclosed herein is that the architecture is able to be abstracted and scaled to various levels, such as from an individual chip to an entire building, so that the same management style, definitions, and linkage structure can be used as the size of the fabric changes. Even without scaling of hardware, such an approach can be used to maintain the health and resiliency or a system at a datacenter scale and with a unified interface structure. This maintenance, in many instances, can be performed without manual intervention, which helps to avoid unnecessary downtime and incur additional expense. Such approaches also enable a fabric to be coherent at high data transfer speeds, such as up to 800 gigabytes or higher, as can be made possible using the DPUs, high speed switches and links, and other such components disclosed herein. The use of these components also allows for the sharing of GPU capacity and memory even though the GPUs are running discrete operating systems.

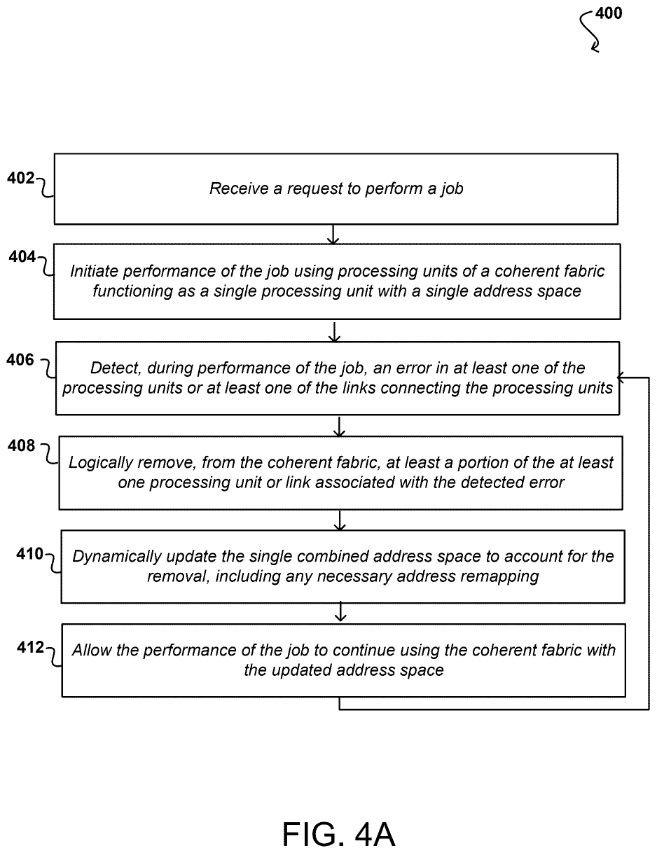

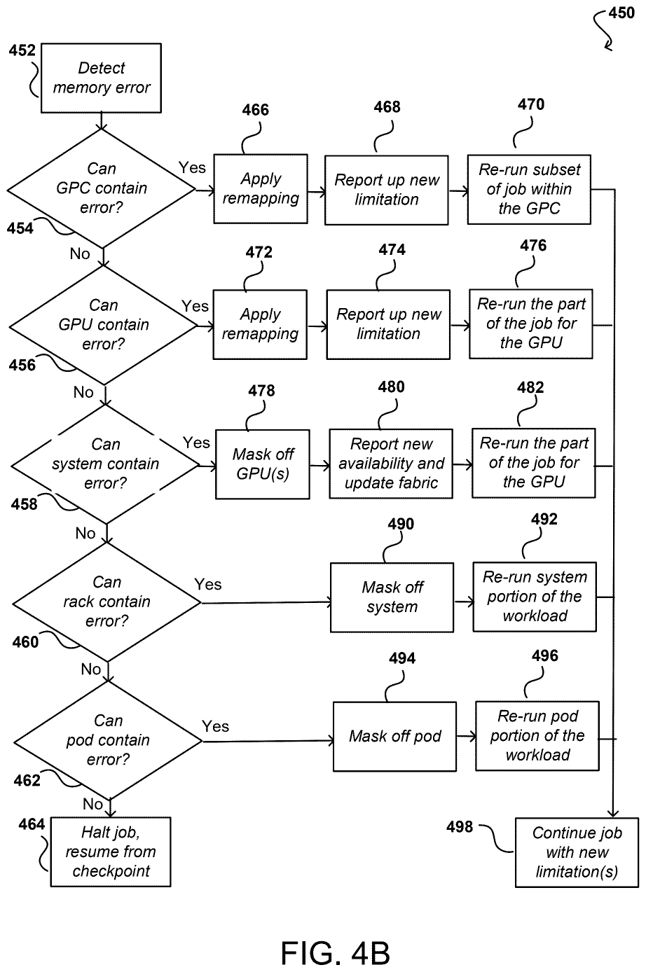

FIG. 4A illustrates an example process 400 that can be performed to identify an error in a group of resources, perform adjustments dynamically to account for the error, and allow processing of a job to continue uninterrupted in accordance with at least one embodiment. It should be understood that for this and other processes discussed herein that there may be additional, fewer, or alternative steps performed in similar or alternative orders, or at least partially in parallel, within the scope of the various embodiments. Further, although discussed with respect to a coherent fabric, it should be understood that advantages of detecting and accounting for errors without interrupting performance of a computing job can be obtained for various other groupings or selections of resources as well within the scope of various embodiments.

In this example process 400, a request is received 402 to perform a job. This may be a large job that will require a number of compute and other such resources to work together to provide sufficient capacity and performance. Performance of the job can be initiated 404 using processing units of a coherent fabric of resources, which can function (logically) as a large, single processing unit with a single, coherent address space. Portions of the job can be directed to individual resources of the fabric for performance. During performance of the job, an error can be detected 406 in at least one of the processing units or one of the links that connect the processing units to make up the fabric. The error can be any type of error that may impact capacity, such as a bad section of memory, a slow link, and the like. At least a portion of the processing unit(s) and/or link(s) associated with the error can be logically removed 408 from the coherent fabric. This may include, for example, masking off a portion of memory of the GPU from the shared address space or removing a link from usage between components. In at least some embodiments, other adjustments may be made as well, such as to add or modify resource capacity or availability, modify the size of one or more chunks of the job to be processed, or redistribute the performance of the job among various resources, among other such options. The single address space can be dynamically updated 410 to account for the removal (or other adjustment), as may include any appropriate remapping of addresses for the memory space. Performance of the job can be allowed 412 to continue, uninterrupted, using the coherent fabric with the updated address space. A portion of the job may be restarted if needed as a result of the failure, but this will not impact performance of other portions of the job and can be limited in scope based on the level at which the detected error can be corrected.

FIG. 4B illustrates another example process 450 that can be performed according to at least one embodiment. Such a process can attempt to determine the lowest level at which an error can be contained, for example, in order to minimize the impact of the error as well as the amount of a currently executing job that may need to be re-run. In this example process 450, a memory error is detected 452 in a coherent fabric of resources used to perform a large, long-running job. A determination is made 454 as to whether a graphics processing cluster (GPC) can contain the error. If so, remapping can be applied 466 to contain the error at the GPC level, and the new limitation can be reported 468 up to a job manager, fabric manager, and/or resource manager so that subsequent processing can be performed using resources, or portions of resources, that were not removed in order to contain the error. A corresponding portion of the job can then be re-run 470 within the same (or an alternate) GPC. If the GPC is not able to contain the error, then a determination can be made 456 as to whether a graphics processing unit (GPC) can contain the error. If so, remapping can be applied 472 to contain the error at the GPU level, such as to mask out a section of GPU memory, and the new limitation can be reported 474 up to a job manager, fabric manager, and/or resource manager so that subsequent processing can be performed using resources, or portions of resources, that were not removed in order to contain the error. A corresponding portion of the job can then be re-run 476 within the same (or an alternate) GPU. If the GPU is unable to contain the error, then a determination can be made 458 as to whether the error can be contained at a system level. If so, one or more GPUs associated with the error can be masked off 478 from further usage for the job, with the fabric updated and the new ability reported 480 up to a job manager, fabric manager, and/or resource manager so that subsequent processing can be performed using resources, or portions of resources, that were not removed in order to contain the error. A corresponding portion of the job can then be re-run 482 within a different GPU in the same system. If the error is not able to be contained at the system level, then a determination is made 460 as to whether the error can be contained at a rack level. If so, the associated system can be masked off 490 from further usage for the job, and a corresponding portion of the job can be re-run 492 using a different system of the same (or an alternate) rack. If the error is not able to be contained at the rack level, a determination can be made 462 as to whether the error can be contained at a pod level. If so, the associated pod can be masked off 494 from further usage for the job, and a corresponding portion of the job can be re-run 496 using a different pod. After any updating and remapping, the job can continue 498 with the new limitation(s). If the error was determined to be unable to be contained at any of these levels (or other appropriate levels), then the job can be halted 464 and can resume from the appropriate checkpoint after any appropriate modifications or adjustments are made to allow for the resuming. Such changes can be performed automatically and seamlessly, without a failure of the job or introduction of significant latency in performance. As mentioned, the determination of error corrections and fabric modifications can be made intelligently to minimize factors such as impact and cost, to allow for continuance of job performance in the most effective way possible (or at least a highly effective way) using the currently-available address space. The ability to provide such intelligent management can provide various advantages over prior reactive systems that had strict policies on what changes could be made and when, which could negatively impact performance of a job and did not allow for intelligent and real-time adjustment to allow for uninterrupted job performance.

### Datacenter

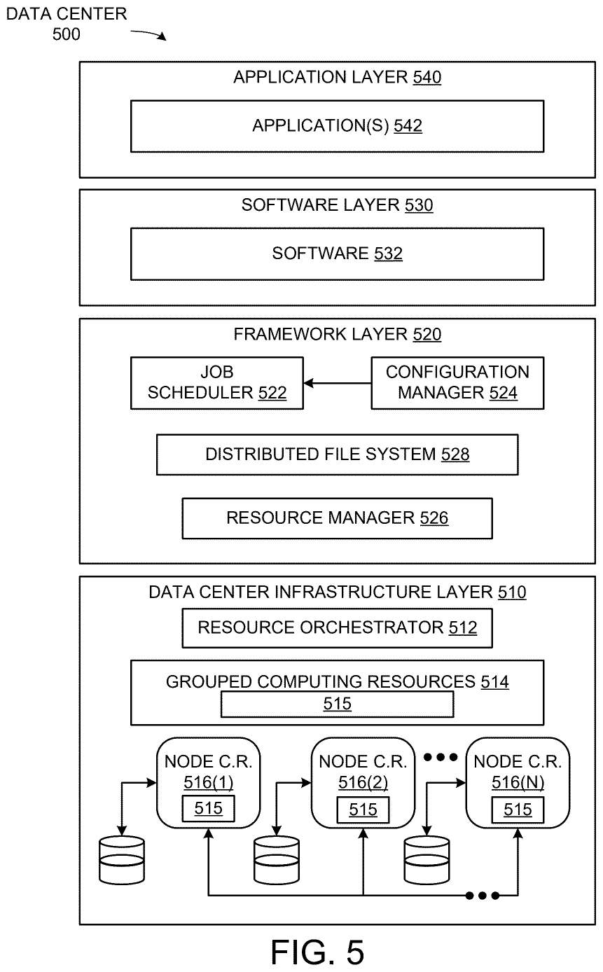

FIG. 5 illustrates the architecture of an example datacenter 500, in which at least one embodiment may be implemented. In at least one embodiment, data in this datacenter 500 includes a datacenter infrastructure layer 510, a framework layer 520, a software layer 530, and an application layer 540.

In at least one embodiment, as shown in FIG. 5, datacenter infrastructure layer 510 may include a resource orchestrator 512, grouped computing resources 514, and node computing resources (“node C.R.s”) 516(1)-516(N), where “N” represents a positive integer (which may be a different integer “N” than used in other figures). In at least one embodiment, node C.R.s 516(1)-516(N) may include, but are not limited to, any number of central processing units (“CPUs”) or other processors (including accelerators, field programmable gate arrays (FPGAs), graphics processors, etc.), memory storage devices 518(1)-518(N) (e.g., dynamic read-only memory, solid state storage or disk drives), network input/output (“NW I/O”) devices, network switches, virtual machines (“VMs”), power modules, and cooling modules, etc. In at least one embodiment, one or more node C.R.s from among node C.R.s 516(1)-516(N) may be a server having one or more of above-mentioned computing resources.

In at least one embodiment, grouped computing resources 514 may include separate groupings of node C.R.s housed within one or more racks (not shown), or many racks housed in datacenters at various geographical locations (also not shown). In at least one embodiment, separate groupings of node C.R.s within grouped computing resources 514 may include grouped compute, network, memory or storage resources that may be configured or allocated to support one or more workloads. In at least one embodiment, several node C.R.s including CPUs or processors may grouped within one or more racks to provide compute resources to support one or more workloads. In at least one embodiment, one or more racks may also include any number of power modules, cooling modules, and network switches, in any combination.

In at least one embodiment, resource orchestrator 512 may configure or otherwise control one or more node C.R.s 516(1)-516(N) and/or grouped computing resources 514. In at least one embodiment, resource orchestrator 512 may include a software design infrastructure (“SDI”) management entity for datacenter 500. In at least one embodiment, resource orchestrator 512 may include hardware, software or some combination thereof.

In at least one embodiment, as shown in FIG. 5, framework layer 520 includes a job scheduler 522, a configuration manager 524, a resource manager 526 and a distributed file system 528. In at least one embodiment, framework layer 520 may include a framework to support software 532 of software layer 530 and/or one or more application(s) 542 of application layer 540. In at least one embodiment, software 532 or application(s) 542 may respectively include web-based service software or applications, such as those provided by Amazon Web Services, Google Cloud and Microsoft Azure. In at least one embodiment, framework layer 520 may be, but is not limited to, a type of free and open-source software web application framework such as Apache Spark™ (hereinafter “Spark”) that may utilize distributed file system 528 for large-scale data processing (e.g., “big data”). In at least one embodiment, job scheduler 522 may include a Spark driver to facilitate scheduling of workloads supported by various layers of datacenter 500. In at least one embodiment, configuration manager 524 may be capable of configuring different layers such as software layer 530 and framework layer 520 including Spark and distributed file system 528 for supporting large-scale data processing. In at least one embodiment, resource manager 526 may be capable of managing clustered or grouped computing resources mapped to or allocated for support of distributed file system 528 and job scheduler 522. In at least one embodiment, clustered or grouped computing resources may include grouped computing resources 514 at datacenter infrastructure layer 510. In at least one embodiment, resource manager 526 may coordinate with resource orchestrator 512 to manage these mapped or allocated computing resources.

In at least one embodiment, software 532 included in software layer 530 may include software used by at least portions of node C.R.s 516(1)-516(N), grouped computing resources 514, and/or distributed file system 528 of framework layer 520. In at least one embodiment, one or more types of software may include, but are not limited to, Internet web page search software, e-mail virus scan software, database software, and streaming video content software.

In at least one embodiment, application(s) 542 included in application layer 540 may include one or more types of applications used by at least portions of node C.R.s 516(1)-516(N), grouped computing resources 514, and/or distributed file system 528 of framework layer 520. In at least one embodiment, one or more types of applications may include, but are not limited to, any number of a genomics application, a cognitive compute, application and a machine learning application, including training or inferencing software, machine learning framework software (e.g., PyTorch, TensorFlow, Caffe, etc.) or other machine learning applications used in conjunction with one or more embodiments.

In at least one embodiment, any of configuration manager 524, resource manager 526, and resource orchestrator 512 may implement any number and type of self-modifying actions based on any amount and type of data acquired in any technically feasible fashion. In at least one embodiment, self-modifying actions may relieve a datacenter operator of datacenter 500 from making possibly bad configuration decisions and possibly avoiding underutilized and/or poor performing portions of a datacenter.

In at least one embodiment, datacenter 500 may include tools, services, software or other resources to train one or more machine learning models or predict or infer information using one or more machine learning models according to one or more embodiments described herein. For example, in at least one embodiment, a machine learning model may be trained by calculating weight parameters according to a neural network architecture using software and computing resources described above with respect to datacenter 500. In at least one embodiment, trained machine learning models corresponding to one or more neural networks may be used to infer or predict information using resources described above with respect to datacenter 500 by using weight parameters calculated through one or more training techniques described herein.

In at least one embodiment, datacenter may use CPUs, application-specific integrated circuits (ASICs), GPUs, FPGAs, or other hardware to perform training and/or inferencing using above-described resources. Moreover, one or more software and/or hardware resources described above may be configured as a service to allow users to train or performing inferencing of information, such as image recognition, speech recognition, or other artificial intelligence services.

Inference and/or training logic 515 are used to perform inferencing and/or training operations associated with one or more embodiments. In at least one embodiment, inference and/or training logic 515 may be used in system FIG. 5 for inferencing or predicting operations based, at least in part, on weight parameters calculated using neural network training operations, neural network functions and/or architectures, or neural network use cases described herein.

Embodiments presented herein can allow for the dynamic and intelligent management of errors identified with respect to at least one resource of a group of resources during performance of a large computing job.

### Computer Systems

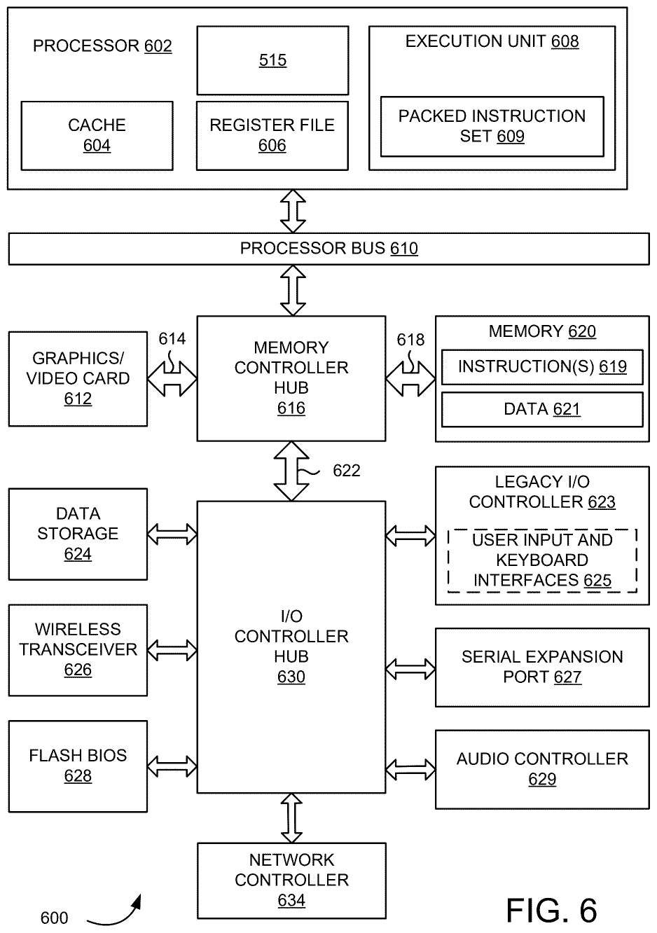

FIG. 6 is a block diagram illustrating an exemplary computer system, which may be a system with interconnected devices and components, a system-on-a-chip (SOC) or some combination thereof formed with a processor that may include execution units to execute an instruction, according to at least one embodiment. In at least one embodiment, a computer system 600 may include, without limitation, a component, such as a processor 602 to employ execution units including logic to perform algorithms for process data, in accordance with present disclosure, such as in embodiment described herein. In at least one embodiment, computer system 600 may include processors, such as PENTIUM® Processor family, Xeon™, Itanium®, Scale™ and/or StrongARM™, Intel® Core™, or Intel® Nirvana™ microprocessors available from Intel Corporation of Santa Clara, California, although other systems (including PCs having other microprocessors, engineering workstations, set-top boxes and like) may also be used. In at least one embodiment, computer system 600 may execute a version of WINDOWS operating system available from Microsoft Corporation of Redmond, Wash., although other operating systems (UNIX and Linux, for example), embedded software, and/or graphical user interfaces, may also be used.

Embodiments may be used in other devices such as handheld devices and embedded applications. Some examples of handheld devices include cellular phones, Internet Protocol devices, digital cameras, personal digital assistants (“PDAs”), and handheld PCs. In at least one embodiment, embedded applications may include a microcontroller, a digital signal processor (“DSP”), system on a chip, network computers (“Necks”), set-top boxes, network hubs, wide area network (“WAN”) switches, or any other system that may perform one or more instructions in accordance with at least one embodiment.

In at least one embodiment, computer system 600 may include, without limitation, processor 602 that may include, without limitation, one or more execution units 608 to perform machine learning model training and/or inferencing according to techniques described herein. In at least one embodiment, computer system 600 is a single processor desktop or server system, but in another embodiment, computer system 600 may be a multiprocessor system. In at least one embodiment, processor 602 may include, without limitation, a complex instruction set computer (“CISC”) microprocessor, a reduced instruction set computing (“RISC”) microprocessor, a very long instruction word (“VLIW”) microprocessor, a processor implementing a combination of instruction sets, or any other processor device, such as a digital signal processor, for example. In at least one embodiment, processor 602 may be coupled to a processor bus 610 that may transmit data signals between processor 602 and other components in computer system 600.

In at least one embodiment, processor 602 may include, without limitation, a Level 1 (“L1”) internal cache memory (“cache”) 604. In at least one embodiment, processor 602 may have a single internal cache or multiple levels of internal cache. In at least one embodiment, cache memory may reside external to processor 602. Other embodiments may also include a combination of both internal and external caches depending on particular implementation and needs. In at least one embodiment, a register file 606 may store different types of data in various registers including, without limitation, integer registers, floating point registers, status registers, and an instruction pointer register.

In at least one embodiment, execution unit 608, including, without limitation, logic to perform integer and floating point operations, also resides in processor 602. In at least one embodiment, processor 602 may also include a microcode (“code”) read only memory (“ROM”) that stores microcode for certain macro instructions. In at least one embodiment, execution unit 608 may include logic to handle a packed instruction set 609. In at least one embodiment, by including packed instruction set 609 in an instruction set of a general-purpose processor, along with associated circuitry to execute instructions, operations used by many multimedia applications may be performed using packed data in processor 602. In at least one embodiment, many multimedia applications may be accelerated and executed more efficiently by using a full width of a processor's data bus for performing operations on packed data, which may eliminate a need to transfer smaller units of data across that processor's data bus to perform one or more operations one data element at a time.

In at least one embodiment, execution unit 608 may also be used in microcontrollers, embedded processors, graphics devices, DSPs, and other types of logic circuits. In at least one embodiment, computer system 600 may include, without limitation, a memory 620. In at least one embodiment, memory 620 may be a Dynamic Random Access Memory (“DRAM”) device, a Static Random Access Memory (“SRAM”) device, a flash memory device, or another memory device. In at least one embodiment, memory 620 may store instruction(s) 619 and/or data 621 represented by data signals that may be executed by processor 602.

In at least one embodiment, a system logic chip may be coupled to processor bus 610 and memory 620. In at least one embodiment, a system logic chip may include, without limitation, a memory controller hub (“MCH”) 616, and processor 602 may communicate with MCH 616 via processor bus 610. In at least one embodiment, MCH 616 may provide a high bandwidth memory path 618 to memory 620 for instruction and data storage and for storage of graphics commands, data, and textures. In at least one embodiment, MCH 616 may direct data signals between processor 602, memory 620, and other components in computer system 600 and to bridge data signals between processor bus 610, memory 620, and a system I/O interface 622. In at least one embodiment, a system logic chip may provide a graphics port for coupling to a graphics controller. In at least one embodiment, MCH 616 may be coupled to memory 620 through high bandwidth memory path 618 and a graphics/video card 612 may be coupled to MCH 616 through an Accelerated Graphics Port (“AGP”) interconnect 614.

In at least one embodiment, computer system 600 may use system I/O interface 622 as a proprietary hub interface bus to couple MCH 616 to an I/O controller hub (“ICH”) 630. In at least one embodiment, ICH 630 may provide direct connections to some I/O devices via a local I/O bus. In at least one embodiment, a local I/O bus may include, without limitation, a high speed I/O bus for connecting peripherals to memory 620, a chipset, and processor 602.

Examples may include, without limitation, an audio controller 629, a firmware hub (“flash BIOS”) 628, a wireless transceiver 626, a data storage 624, a legacy I/O controller 623 containing user input and keyboard interfaces 625, a serial expansion port 627, such as a Universal Serial Bus (“USB”) port, and a network controller 634. In at least one embodiment, data storage 624 may comprise a hard disk drive, a floppy disk drive, a CD-ROM device, a flash memory device, or other mass storage device.

In at least one embodiment, FIG. 6 illustrates a system, which includes interconnected hardware devices or “chips”, whereas in other embodiments, FIG. 6 may illustrate an exemplary SoC In at least one embodiment, devices illustrated in FIG. 6 may be interconnected with proprietary interconnects, standardized interconnects (e.g., PCIe) or some combination thereof. In at least one embodiment, one or more components of computer system 600 are interconnected using compute express link (CXL) interconnects.

Inference and/or training logic 515 are used to perform inferencing and/or training operations associated with one or more embodiments. In at least one embodiment, inference and/or training logic 515 may be used in system FIG. 6 for inferencing or predicting operations based, at least in part, on weight parameters calculated using neural network training operations, neural network functions and/or architectures, or neural network use cases described herein.

Embodiments presented herein can allow for the dynamic and intelligent management of errors identified with respect to at least one resource of a group of resources during performance of a large computing job.

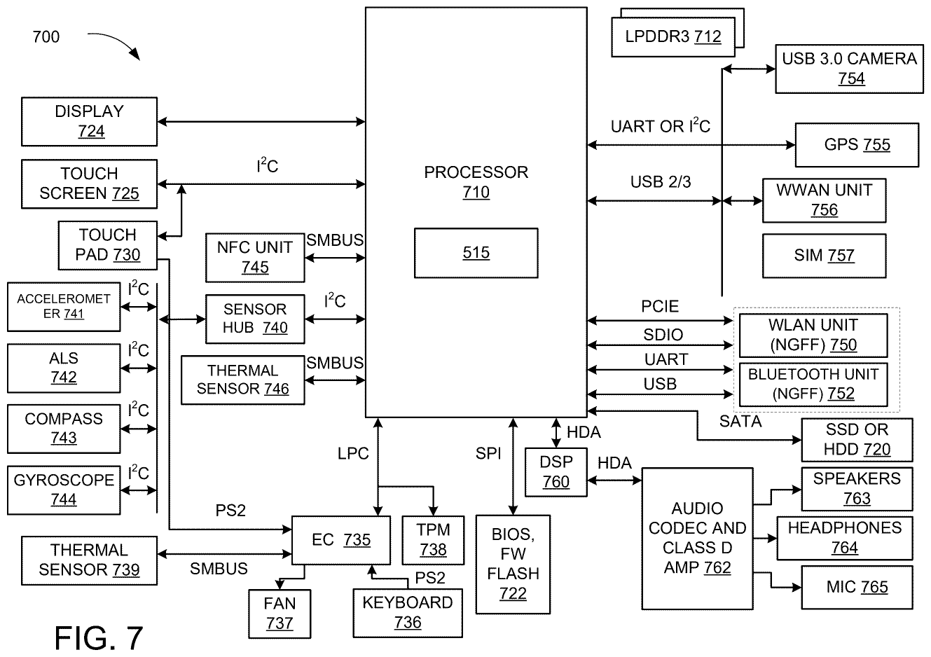

FIG. 7 is a block diagram illustrating an electronic device 700 for utilizing a processor 710, according to at least one embodiment. In at least one embodiment, electronic device 700 may be, for example and without limitation, a notebook, a tower server, a rack server, a blade server, a laptop, a desktop, a tablet, a mobile device, a phone, an embedded computer, or any other suitable electronic device.

In at least one embodiment, electronic device 700 may include, without limitation, processor 710 communicatively coupled to any suitable number or kind of components, peripherals, modules, or devices. In at least one embodiment, processor 710 is coupled using a bus or interface, such as a I²C bus, a System Management Bus (“Sambas”), a Low Pin Count (LPC) bus, a Serial Peripheral Interface (“SPI”), a High Definition Audio (“HDA”) bus, a Serial Advance Technology Attachment (“SATA”) bus, a Universal Serial Bus (“USB”) (versions 1, 2, 3, etc.), or a Universal Asynchronous Receiver/Transmitter (“UART”) bus. In at least one embodiment, FIG. 7 illustrates a system, which includes interconnected hardware devices or “chips”, whereas in other embodiments, FIG. 7 may illustrate an exemplary SoC. In at least one embodiment, devices illustrated in FIG. 7 may be interconnected with proprietary interconnects, standardized interconnects (e.g., PCIe) or some combination thereof. In at least one embodiment, one or more components of FIG. 7 are interconnected using compute express link (CXL) interconnects.

In at least one embodiment, FIG. 7 may include a display 724, a touch screen 725, a touch pad 730, a Near Field Communications unit (“NFC”) 745, a sensor hub 740, a thermal sensor 746, an Express Chipset (“EC”) 735, a Trusted Platform Module (“TPM”) 738, BIOS/firmware/flash memory (“BIOS, FW Flash”) 722, a DSP 760, a drive 720 such as a Solid State Disk (“SSD”) or a Hard Disk Drive (“HDD”), a wireless local area network unit (“WLAN”) 750, a Bluetooth unit 752, a Wireless Wide Area Network unit (“WWAN”) 756, a Global Positioning System (GPS) unit 755, a camera (“USB 3.0 camera”) 754 such as a USB 3.0 camera, and/or a Low Power Double Data Rate (“LPDDR”) memory unit (“LPDDR3”) 715 implemented in, for example, an LPDDR3 standard. These components may each be implemented in any suitable manner.

In at least one embodiment, other components may be communicatively coupled to processor 710 through components described herein. In at least one embodiment, an accelerometer 741, an ambient light sensor (“ALS”) 742, a compass 743, and a gyroscope 744 may be communicatively coupled to sensor hub 740. In at least one embodiment, a thermal sensor 739, a fan 737, a keyboard 736, and touch pad 730 may be communicatively coupled to EC 735. In at least one embodiment, speakers 763, headphones 764, and a microphone (“mic”) 765 may be communicatively coupled to an audio unit (“audio codec and class D amp”) 762, which may in turn be communicatively coupled to DSP 760. In at least one embodiment, audio unit 762 may include, for example and without limitation, an audio coder/decoder (“codec”) and a class D amplifier. In at least one embodiment, a SIM card (“SIM”) 757 may be communicatively coupled to WWAN unit 756. In at least one embodiment, components such as WLAN unit 750 and Bluetooth unit 752, as well as WWAN unit 756 may be implemented in a Next Generation Form Factor (“NGFF”).

Inference and/or training logic 515 are used to perform inferencing and/or training operations associated with one or more embodiments. In at least one embodiment, inference and/or training logic 515 may be used in system FIG. 7 for inferencing or predicting operations based, at least in part, on weight parameters calculated using neural network training operations, neural network functions and/or architectures, or neural network use cases described herein.

Embodiments presented herein can allow for the dynamic and intelligent management of errors identified with respect to at least one resource of a group of resources during performance of a large computing job.

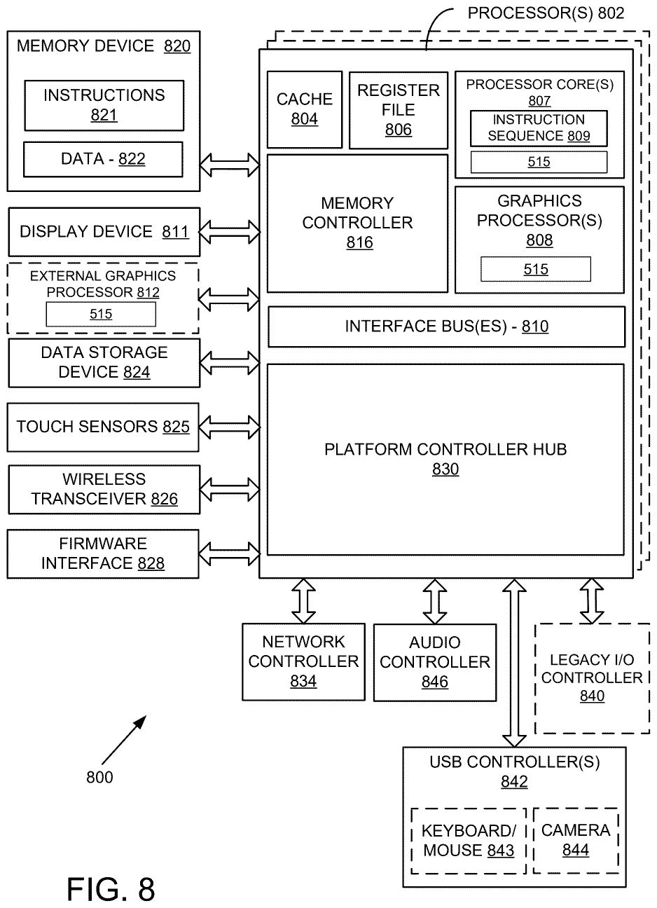

FIG. 8 is a block diagram of a processing system, according to at least one embodiment. In at least one embodiment, system 800 includes one or more processor(s) 802 and one or more graphics processor(s) 808, and may be a single processor desktop system, a multiprocessor workstation system, or a server system having a large number of processor(s) 802 or processor core(s) 807. In at least one embodiment, system 800 is a processing platform incorporated within a system-on-a-chip (SoC) integrated circuit for use in mobile, handheld, or embedded devices. In at least one embodiment, one or more graphics processor(s) 808 include one or more graphics cores.

In at least one embodiment, system 800 can include, or be incorporated within a server-based gaming platform, a game console, including a game and media console, a mobile gaming console, a handheld game console, or an online game console. In at least one embodiment, system 800 is a mobile phone, a smart phone, a tablet computing device or a mobile Internet device. In at least one embodiment, processing system 800 can also include, couple with, or be integrated within a wearable device, such as a smart watch wearable device, a smart eyewear device, an augmented reality device, or a virtual reality device. In at least one embodiment, processing system 800 is a television or set top box device having one or more processor(s) 802 and a graphical interface generated by one or more graphics processor(s) 808.

In at least one embodiment, one or more processor(s) 802 each include one or more processor core(s) 807 to process instructions which, when executed, perform operations for system and user software. In at least one embodiment, each of one or more processor core(s) 807 is configured to process a specific instruction sequence 809. In at least one embodiment, instruction sequence 809 may facilitate Complex Instruction Set Computing (CISC), Reduced Instruction Set Computing (RISC), or computing via a Very Long Instruction Word (VLIW). In at least one embodiment, processor core(s) 807 may each process a different instruction sequence 809, which may include instructions to facilitate emulation of other instruction sequences. In at least one embodiment, processor core(s) 807 may also include other processing devices, such a Digital Signal Processor (DSP).

In at least one embodiment, processor(s) 802 includes a cache memory 804. In at least one embodiment, processor(s) 802 can have a single internal cache or multiple levels of internal cache. In at least one embodiment, cache memory is shared among various components of processor(s) 802. In at least one embodiment, processor(s) 802 also uses an external cache (e.g., a Level-3 (L3) cache or Last Level Cache (LLC)) (not shown), which may be shared among processor core(s) 807 using known cache coherency techniques. In at least one embodiment, a register file 806 is additionally included in processor(s) 802, which may include different types of registers for storing different types of data (e.g., integer registers, floating point registers, status registers, and an instruction pointer register). In at least one embodiment, register file 806 may include general-purpose registers or other registers.

In at least one embodiment, one or more processor(s) 802 are coupled with one or more interface bus(es) 810 to transmit communication signals such as address, data, or control signals between processor(s) 802 and other components in system 800. In at least one embodiment, interface bus(es) 810 can be a processor bus, such as a version of a Direct Media Interface (DMI) bus. In at least one embodiment, interface bus(es) 810 is not limited to a DMI bus, and may include one or more Peripheral Component Interconnect buses (e.g., PCI, PCI Express), memory busses, or other types of interface busses. In at least one embodiment processor(s) 802 include an integrated memory controller 816 and a platform controller hub 830. In at least one embodiment, memory controller 816 facilitates communication between a memory device and other components of system 800, while platform controller hub (PCH) 830 provides connections to I/O devices via a local I/O bus.

In at least one embodiment, a memory device 820 can be a dynamic random access memory (DRAM) device, a static random access memory (SRAM) device, flash memory device, phase-change memory device, or some other memory device having suitable performance to serve as process memory. In at least one embodiment, memory device 820 can operate as system memory for system 800, to store data 822 and instructions 821 for use when one or more processor(s) 802 executes an application or process. In at least one embodiment, memory controller 816 also couples with an optional external graphics processor 812, which may communicate with one or more graphics processor(s) 808 in processor(s) 802 to perform graphics and media operations. In at least one embodiment, a display device 811 can connect to processor(s) 802. In at least one embodiment, display device 811 can include one or more of an internal display device, as in a mobile electronic device or a laptop device, or an external display device attached via a display interface (e.g., DisplayPort, etc.). In at least one embodiment, display device 811 can include a head mounted display (HMD) such as a stereoscopic display device for use in virtual reality (VR) applications or augmented reality (AR) applications.

In at least one embodiment, platform controller hub 830 enables peripherals to connect to memory device 820 and processor(s) 802 via a high speed I/O bus. In at least one embodiment, I/O peripherals include, but are not limited to, an audio controller 846, a network controller 834, a firmware interface 828, a wireless transceiver 826, touch sensors 825, a data storage device 824 (e.g., hard disk drive, flash memory, etc.). In at least one embodiment, data storage device 824 can connect via a storage interface (e.g., SATA) or via a peripheral bus, such as a Peripheral Component Interconnect bus (e.g., PCI, PCI Express). In at least one embodiment, touch sensors 825 can include touch screen sensors, pressure sensors, or fingerprint sensors. In at least one embodiment, wireless transceiver 826 can be a Wi-Fi transceiver, a Bluetooth transceiver, or a mobile network transceiver such as a 3G, 4G, or Long Term Evolution (LTE) transceiver. In at least one embodiment, firmware interface 828 enables communication with system firmware, and can be, for example, a unified extensible firmware interface (UEFI). In at least one embodiment, network controller 834 can enable a network connection to a wired network. In at least one embodiment, a high-performance network controller (not shown) couples with interface bus(es) 810. In at least one embodiment, audio controller 846 is a multi-channel high definition audio controller. In at least one embodiment, system 800 includes an optional legacy I/O controller 840 for coupling legacy (e.g., Personal System 2 (PS/2)) devices to system 800. In at least one embodiment, platform controller hub 830 can also connect to one or more Universal Serial Bus (USB) controller(s) 842 connect input devices, such as keyboard and mouse 843 combinations, a camera 844, or other USB input devices.

In at least one embodiment, an instance of memory controller 816 and platform controller hub 830 may be integrated into a discreet external graphics processor, such as external graphics processor 812. In at least one embodiment, platform controller hub 830 and/or memory controller 816 may be external to one or more processor(s) 802. For example, in at least one embodiment, system 800 can include an external memory controller 816 and platform controller hub 830, which may be configured as a memory controller hub and peripheral controller hub within a system chipset that is in communication with processor(s) 802.

Embodiments presented herein can allow for the dynamic and intelligent management of errors identified with respect to at least one resource of a group of resources during performance of a large computing job.

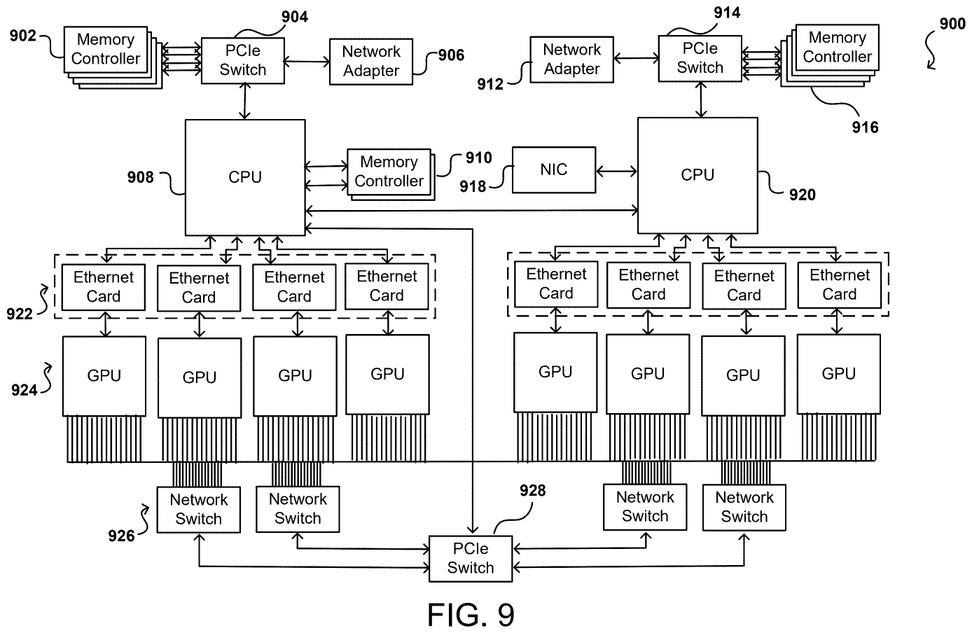

FIG. 9 illustrates an example enterprise AI system that can be used to perform at least AI-related tasks in accordance with at least one embodiment. An example of such a system is an H100 or H200 DGX system implementing the NVIDIA DGX™ platform from NVIDIA Corporation. The NVIDIA DGX™ H100/H200 Systems are built for all AI infrastructure and workloads from analytics to training to inference. The DGX H100/H200 systems are built on eight GPUs 924, such as NVIDIA H100 Tensor Core GPUs or eight NVIDIA H200 Tensor Core GPUs. Although not illustrated in FIG. 9, other types of processing units can be used as well, such as data processing units (DPUs). The illustrated system 900 includes a pair of CPUs 908, 920, such as Intel Xeon CPUs with 56 cores each. The CPUs 908, 920 are connected to the eight GPUs 924 using a set of Ethernet cards 922, such as ConnectX-7 Network Modules, which are connected in turn to a number of network switches 926, such as NVSwitches. The network switches 926 are connected to a PCIe switch 928, which can be connected back to at least one of the CPUs 908. A first CPU 908 can be connected directly to a memory controller 910, such as an NVMe controller, and to other memory controllers 902 indirectly through a PCIe switch 904, which can also connect the CPU 908 to a network adapter 906, such as a ConnectX-7 adapter. A second CPU 920 can be connected to the first CPU 908 as well as a network interface card (NIC) 918. The second CPU 920 can also be connected, through another PCIe switch 914, to a network adapter 912 and one or more memory controllers 916.

An example Nvidia DGX (Deep GPU Xceleration) implementation can include a number of servers and workstations that are geared towards enhancing deep learning applications through the use of general-purpose computing on graphics processing units (GPUs). Such systems may come in a rackmount format featuring high-performance x86 server CPUs on the motherboard. A core feature of an example DGX system is its inclusion of 8 or more NVIDIA GPU modules, which are housed on an independent system board. These GPUs can be connected either via a version of the SXM socket or a PCIe x16 slot, facilitating flexible integration within the system architecture. To manage the substantial thermal output, DGX units are equipped with heatsinks and fans designed to maintain optimal operating temperatures. This framework makes DGX units suitable for computational tasks associated with artificial intelligence and machine learning models. In one embodiment, the GPUs can be connected using an NVLink mesh network.

Embodiments presented herein can allow for the dynamic and intelligent management of errors identified with respect to at least one resource of a group of resources during performance of a large computing job.

### Virtualized Computing Platform

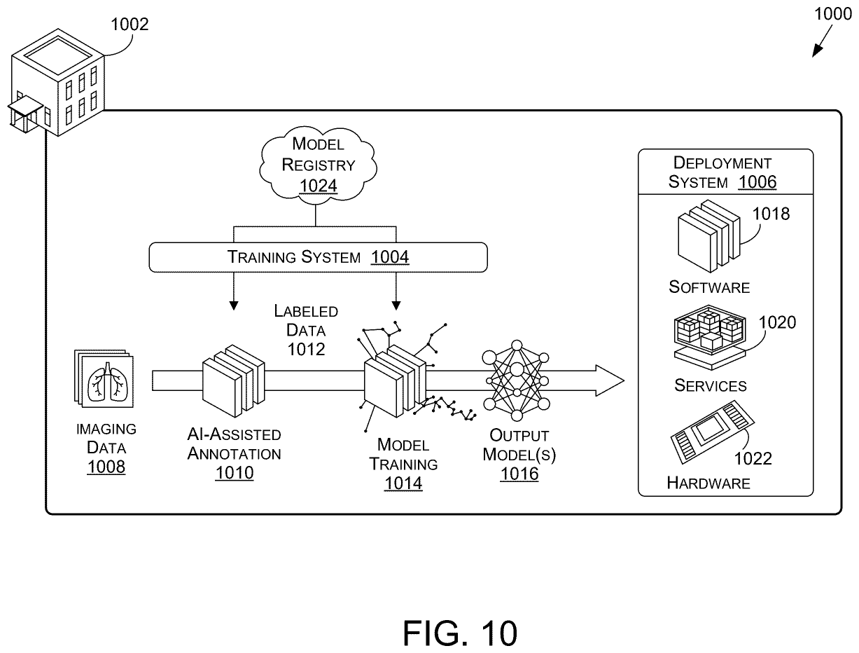

FIG. 10 is an example data flow diagram for a process 1000 of generating and deploying an image processing and inferencing pipeline, in accordance with at least one embodiment. In at least one embodiment, process 1000 may be deployed for use with imaging devices, processing devices, and/or other device types at one or more facilities 1002. Process 1000 may be executed within a training system 1004 and/or a deployment system 1006. In at least one embodiment, training system 1004 may be used to perform training, deployment, and implementation of machine learning models (e.g., neural networks, object detection algorithms, computer vision algorithms, etc.) for use in deployment system 1006. In at least one embodiment, deployment system 1006 may be configured to offload processing and compute resources among a distributed computing environment to reduce infrastructure requirements at facility 1002. In at least one embodiment, one or more applications in a pipeline may use or call upon services (e.g., inference, visualization, compute, AI, etc.) of deployment system 1006 during execution of applications.

In at least one embodiment, some of applications used in advanced processing and inferencing pipelines may use machine learning models or other AI to perform one or more processing steps. In at least one embodiment, machine learning models may be trained at facility 1002 using data 1008 (such as imaging data) generated at facility 1002 (and stored on one or more picture archiving and communication system (PACS) servers at facility 1002), may be trained using imaging or sequencing data 1008 from another facility(ies), or a combination thereof. In at least one embodiment, training system 1004 may be used to provide applications, services, and/or other resources for generating working, deployable machine learning models for deployment system 1006.

In at least one embodiment, model registry 1024 may be backed by object storage that may support versioning and object metadata. In at least one embodiment, object storage may be accessible through, for example, a cloud storage compatible application programming interface (API) from within a cloud platform. In at least one embodiment, machine learning models within model registry 1024 may uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, training system 1004 may include a scenario where facility 1002 is training their own machine learning model, or has an existing machine learning model that needs to be optimized or updated. In at least one embodiment, imaging data 1008 generated by imaging device(s), sequencing devices, and/or other device types may be received. In at least one embodiment, once imaging data 1008 is received, AI-assisted annotation 1010 may be used to aid in generating annotations corresponding to imaging data 1008 to be used as ground truth data for a machine learning model. In at least one embodiment, AI-assisted annotation 1010 may include one or more machine learning models (e.g., convolutional neural networks (CNNs)) that may be trained to generate annotations corresponding to certain types of imaging data 1008 (e.g., from certain devices). In at least one embodiment, AI-assisted annotation 1010 may then be used directly, or may be adjusted or fine-tuned using an annotation tool to generate ground truth data. In at least one embodiment, AI-assisted annotation 1010, labeled data 1012, or a combination thereof may be used as ground truth data for training a machine learning model. In at least one embodiment, a trained machine learning model may be referred to as output model(s) 1016, and may be used by deployment system 1006, as described herein.

In at least one embodiment, a training pipeline may include a scenario where facility 1002 needs a machine learning model for use in performing one or more processing tasks for one or more applications in deployment system 1006, but facility 1002 may not currently have such a machine learning model (or may not have a model that is optimized, efficient, or effective for such purposes). In at least one embodiment, an existing machine learning model may be selected from a model registry 1024. In at least one embodiment, model registry 1024 may include machine learning models trained to perform a variety of different inference tasks on imaging data. In at least one embodiment, machine learning models in model registry 1024 may have been trained on imaging data from different facilities than facility 1002 (e.g., facilities remotely located). In at least one embodiment, machine learning models may have been trained on imaging data from one location, two locations, or any number of locations. In at least one embodiment, when being trained on imaging data from a specific location, training may take place at that location, or at least in a manner that protects confidentiality of imaging data or restricts imaging data from being transferred off-premises. In at least one embodiment, once a model is trained—or partially trained—at one location, a machine learning model may be added to model registry 1024. In at least one embodiment, a machine learning model may then be retrained, or updated, at any number of other facilities, and a retrained or updated model may be made available in model registry 1024. In at least one embodiment, a machine learning model may then be selected from model registry 1024—and referred to as output model(s) 1016—and may be used in deployment system 1006 to perform one or more processing tasks for one or more applications of a deployment system.

In at least one embodiment, a scenario may include facility 1002 requiring a machine learning model for use in performing one or more processing tasks for one or more applications in deployment system 1006, but facility 1002 may not currently have such a machine learning model (or may not have a model that is optimized, efficient, or effective for such purposes). In at least one embodiment, a machine learning model selected from model registry 1024 may not be fine-tuned or optimized for imaging data 1008 generated at facility 1002 because of differences in populations, robustness of training data used to train a machine learning model, diversity in anomalies of training data, and/or other issues with training data. In at least one embodiment, AI-assisted annotation 1010 may be used to aid in generating annotations corresponding to imaging data 1008 to be used as ground truth data for retraining or updating a machine learning model. In at least one embodiment, labeled data 1012 may be used as ground truth data for training a machine learning model. In at least one embodiment, retraining or updating a machine learning model may be referred to as model training 1014. In at least one embodiment, model training 1014—e.g., AI-assisted annotation 1010, labeled data 1012, or a combination thereof—may be used as ground truth data for retraining or updating a machine learning model. In at least one embodiment, a trained machine learning model may be referred to as output model(s) 1016, and may be used by deployment system 1006, as described herein.

In at least one embodiment, deployment system 1006 may include software 1018, services 1020, hardware 1022, and/or other components, features, and functionality. In at least one embodiment, deployment system 1006 may include a software “stack,” such that software 1018 may be built on top of services 1020 and may use services 1020 to perform some or all of processing tasks, and services 1020 and software 1018 may be built on top of hardware 1022 and use hardware 1022 to execute processing, storage, and/or other compute tasks of deployment system 1006. In at least one embodiment, software 1018 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, an advanced processing and inferencing pipeline may be defined based on selections of different containers that are desired or required for processing imaging data 1008, in addition to containers that receive and configure imaging data for use by each container and/or for use by facility 1002 after processing through a pipeline (e.g., to convert outputs back to a usable data type). In at least one embodiment, a combination of containers within software 1018 (e.g., that make up a pipeline) may be referred to as a virtual instrument (as described in more detail herein), and a virtual instrument may leverage services 1020 and hardware 1022 to execute some or all processing tasks of applications instantiated in containers.

In at least one embodiment, a data processing pipeline may receive input data (e.g., imaging data 1008) in a specific format in response to an inference request (e.g., a request from a user of deployment system 1006). In at least one embodiment, input data may be representative of one or more images, video, and/or other data representations generated by one or more imaging devices. In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1016 of training system 1004.

In at least one embodiment, tasks of data processing pipeline may be encapsulated in a container(s) that each represents a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1024 and associated with one or more applications. In at least one embodiment, images of applications (e.g., container images) may be available in a container registry, and once selected by a user from a container registry for deployment in a pipeline, an image may be used to generate a container for an instantiation of an application for use by a user's system.

In at least one embodiment, developers (e.g., software developers, clinicians, doctors, etc.) may develop, publish, and store applications (e.g., as containers) for performing image processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1020 as a system. In at least one embodiment, because DICOM objects may contain anywhere from one to hundreds of images or other data types, and due to a variation in data, a developer may be responsible for managing (e.g., setting constructs for, building pre-processing into an application, etc.) extraction and preparation of incoming data. In at least one embodiment, once validated by process 1000 (e.g., for accuracy), an application may be available in a container registry for selection and/or implementation by a user to perform one or more processing tasks with respect to data at a facility (e.g., a second facility) of a user.

In at least one embodiment, developers may then share applications or containers through a network for access and use by users of a system. In at least one embodiment, completed and validated applications or containers may be stored in a container registry and associated machine learning models may be stored in model registry 1024. In at least one embodiment, a requesting entity—who provides an inference or image processing request—may browse a container registry and/or model registry 1024 for an application, container, dataset, machine learning model, etc., select a desired combination of elements for inclusion in data processing pipeline, and submit an imaging processing request. In at least one embodiment, a request may include input data (and associated patient data, in some examples) that is necessary to perform a request, and/or may include a selection of application(s) and/or machine learning models to be executed in processing a request. In at least one embodiment, a request may then be passed to one or more components of deployment system 1006 (e.g., a cloud) to perform processing of data processing pipeline. In at least one embodiment, processing by deployment system 1006 may include referencing selected elements (e.g., applications, containers, models, etc.) from a container registry and/or model registry 1024. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, services 1020 may be leveraged. In at least one embodiment, services 1020 may include compute services, artificial intelligence (AI) services, visualization services, and/or other service types. In at least one embodiment, services 1020 may provide functionality that is common to one or more applications in software 1018, so functionality may be abstracted to a service that may be called upon or leveraged by applications. In at least one embodiment, functionality provided by services 1020 may run dynamically and more efficiently, while also scaling well by allowing applications to process data in parallel (e.g., using a parallel computing platform). In at least one embodiment, rather than each application that shares a same functionality offered by services 1020 being required to have a respective instance of services 1020, services 1020 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities. In at least one embodiment, a data augmentation service may further be included that may provide GPU accelerated data (e.g., DICOM, RIS, CIS, REST compliant, RPC, raw, etc.) extraction, resizing, scaling, and/or other augmentation. In at least one embodiment, a visualization service may be used that may add image rendering effects—such as ray-tracing, rasterization, denoising, sharpening, etc.—to add realism to two-dimensional (2D) and/or three-dimensional (3D) models. In at least one embodiment, virtual instrument services may be included that provide for beam-forming, segmentation, inferencing, imaging, and/or support for other applications within pipelines of virtual instruments.

In at least one embodiment, where services 1020 includes an AI service (e.g., an inference service), one or more machine learning models may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more of processing operations associated with segmentation tasks. In at least one embodiment, software 1018 implementing advanced processing and inferencing pipeline that includes segmentation application and anomaly detection application may be streamlined because each application may call upon a same inference service to perform one or more inferencing tasks.

In at least one embodiment, hardware 1022 may include GPUs, CPUs, graphics cards, an AI/deep learning system (e.g., an AI supercomputer, such as NVIDIA's DGX), a cloud platform, or a combination thereof. In at least one embodiment, different types of hardware 1022 may be used to provide efficient, purpose-built support for software 1018 and services 1020 in deployment system 1006. In at least one embodiment, use of GPU processing may be implemented for processing locally (e.g., at facility 1002), within an AI/deep learning system, in a cloud system, and/or in other processing components of deployment system 1006 to improve efficiency, accuracy, and efficacy of image processing and generation. In at least one embodiment, software 1018 and/or services 1020 may be optimized for GPU processing with respect to deep learning, machine learning, and/or high-performance computing, as non-limiting examples. In at least one embodiment, at least some of computing environment of deployment system 1006 and/or training system 1004 may be executed in a datacenter one or more supercomputers or high-performance computing systems, with GPU optimized software (e.g., hardware and software combination of NVIDIA's DGX System). In at least one embodiment, hardware 1022 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC) may be executed using an AI/deep learning supercomputer(s) and/or GPU-optimized software (e.g., as provided on NVIDIA's DGX Systems) as a hardware abstraction and scaling platform. In at least one embodiment, cloud platform may integrate an application container clustering system or orchestration system (e.g., KUBERNETES) on multiple GPUs to enable seamless scaling and load balancing.

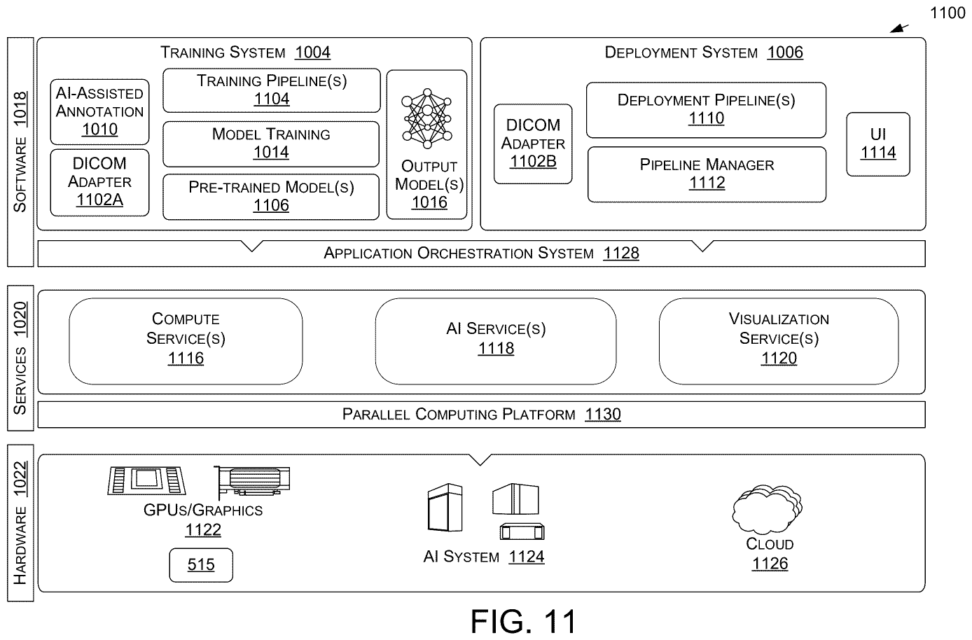

FIG. 11 is a system diagram for an example system 1100 for generating and deploying an imaging deployment pipeline, in accordance with at least one embodiment. In at least one embodiment, system 1100 may be used to implement processes including advanced processing and inferencing pipelines. In at least one embodiment, system 1100 may include training system 1004 and deployment system 1006. In at least one embodiment, training system 1004 and deployment system 1006 may be implemented using software 1018, services 1020, and/or hardware 1022, as described herein.

In at least one embodiment, system 1100 (e.g., training system 1004 and/or deployment system 1006) may implemented in a cloud computing environment (e.g., using cloud 1126). In at least one embodiment, system 1100 may be implemented locally with respect to a healthcare services facility, or as a combination of both cloud and local computing resources. In at least one embodiment, access to APIs in cloud 1126 may be restricted to authorized users through enacted security measures or protocols. In at least one embodiment, a security protocol may include web tokens that may be signed by an authentication (e.g., AuthN, AuthZ, Gluecon, etc.) service and may carry appropriate authorization. In at least one embodiment, APIs of virtual instruments (described herein), or other instantiations of system 1100, may be restricted to a set of public IPs that have been vetted or authorized for interaction.

In at least one embodiment, various components of system 1100 may communicate between and among one another using any of a variety of different network types, including but not limited to local area networks (LANs) and/or wide area networks (WANs) via wired and/or wireless communication protocols. In at least one embodiment, communication between facilities and components of system 1100 (e.g., for transmitting inference requests, for receiving results of inference requests, etc.) may be communicated over data bus(ses), wireless data protocols (Wi-Fi), wired data protocols (e.g., Ethernet), etc.

In at least one embodiment, training system 1004 may execute training pipelines 1104, similar to those described herein with respect to FIG. 10. In at least one embodiment, where one or more machine learning models are to be used in deployment pipeline(s) 1110 by deployment system 1006, training pipelines 1104 may be used to train or retrain one or more (e.g. pre-trained) models, and/or implement one or more of pre-trained models 1106 (e.g., without a need for retraining or updating). In at least one embodiment, as a result of training pipelines 1104, output model(s) 1016 may be generated. In at least one embodiment, training pipelines 1104 may include any number of processing steps, such as but not limited to imaging data (or other input data) conversion or adaption In at least one embodiment, for different machine learning models used by deployment system 1006, different training pipelines 1104 may be used. In at least one embodiment, training pipeline 1104 similar to a first example described with respect to FIG. 10 may be used for a first machine learning model, training pipeline 1104 similar to a second example described with respect to FIG. 10 may be used for a second machine learning model, and training pipeline 1104 similar to a third example described with respect to FIG. 10 may be used for a third machine learning model. In at least one embodiment, any combination of tasks within training system 1004 may be used depending on what is required for each respective machine learning model. In at least one embodiment, one or more of machine learning models may already be trained and ready for deployment so machine learning models may not undergo any processing by training system 1004, and may be implemented by deployment system 1006.

In at least one embodiment, output model(s) 1016 and/or pre-trained models 1106 may include any types of machine learning models depending on implementation or embodiment. In at least one embodiment, and without limitation, machine learning models used by system 1100 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Hopfield, Boltzmann, deep belief, deconvolutional, generative adversarial, liquid state machine, etc.), and/or other types of machine learning models.

In at least one embodiment, training pipelines 1104 may include AI-assisted annotation, as described in more detail herein with respect to at least FIG. 11. In at least one embodiment, labeled data 1012 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of imaging data 1008 (or other data type used by machine learning models), there may be corresponding ground truth data generated by training system 1004. In at least one embodiment, AI-assisted annotation may be performed as part of deployment pipeline(s) 1110; either in addition to, or in lieu of AI-assisted annotation included in training pipelines 1104. In at least one embodiment, system 1100 may include a multi-layer platform that may include a software layer (e.g., software 1018) of diagnostic applications (or other application types) that may perform one or more medical imaging and diagnostic functions. In at least one embodiment, system 1100 may be communicatively coupled to (e.g., via encrypted links) PACS server networks of one or more facilities. In at least one embodiment, system 1100 may be configured to access and referenced data from PACS servers to perform operations, such as training machine learning models, deploying machine learning models, image processing, inferencing, and/or other operations.

In at least one embodiment, a software layer may be implemented as a secure, encrypted, and/or authenticated API through which applications or containers may be invoked (e.g., called) from an external environment(s) (e.g., facility 1002). In at least one embodiment, applications may then call or execute one or more services 1020 for performing compute, AI, or visualization tasks associated with respective applications, and software 1018 and/or services 1020 may leverage hardware 1022 to perform processing tasks in an effective and efficient manner. In at least one embodiment, communications sent to, or received by, a training system 1004 and a deployment system 1006 may occur using a pair of DICOM adapters 1102A, 1102B.

In at least one embodiment, deployment system 1006 may execute deployment pipeline(s) 1110. In at least one embodiment, deployment pipeline(s) 1110 may include any number of applications that may be sequentially, non-sequentially, or otherwise applied to imaging data (and/or other data types) generated by imaging devices, sequencing devices, genomics devices, etc.-including AI-assisted annotation, as described above. In at least one embodiment, as described herein, a deployment pipeline(s) 1110 for an individual device may be referred to as a virtual instrument for a device (e.g., a virtual ultrasound instrument, a virtual CT scan instrument, a virtual sequencing instrument, etc.). In at least one embodiment, for a single device, there may be more than one deployment pipeline(s) 1110 depending on information desired from data generated by a device. In at least one embodiment, where detections of anomalies are desired from an MRI machine, there may be a first deployment pipeline(s) 1110, and where image enhancement is desired from output of an MRI machine, there may be a second deployment pipeline(s) 1110.

In at least one embodiment, an image generation application may include a processing task that includes use of a machine learning model. In at least one embodiment, a user may desire to use their own machine learning model, or to select a machine learning model from model registry 1024. In at least one embodiment, a user may implement their own machine learning model or select a machine learning model for inclusion in an application for performing a processing task. In at least one embodiment, applications may be selectable and customizable, and by defining constructs of applications, deployment and implementation of applications for a particular user are presented as a more seamless user experience. In at least one embodiment, by leveraging other features of system 1100—such as services 1020 and hardware 1022—deployment pipeline(s) 1110 may be even more user friendly, provide for easier integration, and produce more accurate, efficient, and timely results.

In at least one embodiment, deployment system 1006 may include a user interface (“UI”) 1114 (e.g., a graphical user interface, a web interface, etc.) that may be used to select applications for inclusion in deployment pipeline(s) 1110, arrange applications, modify or change applications or parameters or constructs thereof, use and interact with deployment pipeline(s) 1110 during set-up and/or deployment, and/or to otherwise interact with deployment system 1006. In at least one embodiment, although not illustrated with respect to training system 1004, UI 1114 (or a different user interface) may be used for selecting models for use in deployment system 1006, for selecting models for training, or retraining, in training system 1004, and/or for otherwise interacting with training system 1004.

In at least one embodiment, pipeline manager 1112 may be used, in addition to an application orchestration system 1128, to manage interaction between applications or containers of deployment pipeline(s) 1110 and services 1020 and/or hardware 1022. In at least one embodiment, pipeline manager 1112 may be configured to facilitate interactions from application to application, from application to services 1020, and/or from application or service to hardware 1022. In at least one embodiment, although illustrated as included in software 1018, this is not intended to be limiting, and in some examples pipeline manager 1112 may be included in services 1020. In at least one embodiment, application orchestration system 1128 (e.g., Kubernetes, DOCKER, etc.) may include a container orchestration system that may group applications into containers as logical units for coordination, management, scaling, and deployment. In at least one embodiment, by associating applications from deployment pipeline(s) 1110 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of another application(s) or container(s). In at least one embodiment, communication, and cooperation between different containers or applications may be aided by pipeline manager 1112 and application orchestration system 1128. In at least one embodiment, so long as an expected input and/or output of each container or application is known by a system (e.g., based on constructs of applications or containers), application orchestration system 1128 and/or pipeline manager 1112 may facilitate communication among and between, and sharing of resources among and between, each of applications or containers. In at least one embodiment, because one or more of applications or containers in deployment pipeline(s) 1110 may share same services and resources, application orchestration system 1128 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, a scheduler may thus allocate resources to different applications and distribute resources between and among applications in view of requirements and availability of a system. In some examples, a scheduler (and/or other component of application orchestration system 1128) may determine resource availability and distribution based on constraints imposed on a system (e.g., user constraints), such as quality of service (QoS), urgency of need for data outputs (e.g., to determine whether to execute real-time processing or delayed processing), etc.

In at least one embodiment, services 1020 leveraged by and shared by applications or containers in deployment system 1006 may include compute service(s) 1116, AI service(s) 1118, visualization service(s) 1120, and/or other service types. In at least one embodiment, applications may call (e.g., execute) one or more of services 1020 to perform processing operations for an application. In at least one embodiment, compute service(s) 1116 may be leveraged by applications to perform super-computing or other high-performance computing (HPC) tasks. In at least one embodiment, compute service(s) 1116 may be leveraged to perform parallel processing (e.g., using a parallel computing platform 1130) for processing data through one or more of applications and/or one or more tasks of a single application, substantially simultaneously. In at least one embodiment, parallel computing platform 1130 (e.g., NVIDIA's CUDA) may enable general purpose computing on GPUs (GPGPU) (e.g., GPUs/Graphics 1122). In at least one embodiment, a software layer of parallel computing platform 1130 may provide access to virtual instruction sets and parallel computational elements of GPUs, for execution of compute kernels. In at least one embodiment, parallel computing platform 1130 may include memory and, in some embodiments, a memory may be shared between and among multiple containers, and/or between and among different processing tasks within a single container. In at least one embodiment, inter-process communication (IPC) calls may be generated for multiple containers and/or for multiple processes within a container to use same data from a shared segment of memory of parallel computing platform 1130 (e.g., where multiple different stages of an application or multiple applications are processing same information). In at least one embodiment, rather than making a copy of data and moving data to different locations in memory (e.g., a read/write operation), same data in same location of a memory may be used for any number of processing tasks (e.g., at a same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1118 may be leveraged to perform inferencing services for executing machine learning model(s) associated with applications (e.g., tasked with performing one or more processing tasks of an application). In at least one embodiment, AI service(s) 1118 may leverage AI system 1124 to execute machine learning model(s) (e.g., neural networks, such as CNNs) for segmentation, reconstruction, object detection, feature detection, classification, and/or other inferencing tasks. In at least one embodiment, applications of deployment pipeline(s) 1110 may use one or more of output model(s) 1016 from training system 1004 and/or other models of applications to perform inference on imaging data. In at least one embodiment, two or more examples of inferencing using application orchestration system 1128 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1128 may distribute resources (e.g., services 1020 and/or hardware 1022) based on priority paths for different inferencing tasks of AI service(s) 1118.

In at least one embodiment, shared storage may be mounted to AI service(s) 1118 within system 1100. In at least one embodiment, shared storage may operate as a cache (or other storage device type) and may be used to process inference requests from applications. In at least one embodiment, when an inference request is submitted, a request may be received by a set of API instances of deployment system 1006, and one or more instances may be selected (e.g., for best fit, for load balancing, etc.) to process a request. In at least one embodiment, to process a request, a request may be entered into a database, a machine learning model may be located from model registry 1024 if not already in a cache, a validation step may ensure appropriate machine learning model is loaded into a cache (e.g., shared storage), and/or a copy of a model may be saved to a cache. In at least one embodiment, a scheduler (e.g., of pipeline manager 1112) may be used to launch an application that is referenced in a request if an application is not already running or if there are not enough instances of an application. In at least one embodiment, if an inference server is not already launched to execute a model, an inference server may be launched. Any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as inference server is running as a different instance.

In at least one embodiment, during application execution, an inference request for a given application may be received, and a container (e.g., hosting an instance of an inference server) may be loaded (if not already), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel level-segmentation, voxel-level segmentation, generating a visualization, or generating text to summarize findings. In at least one embodiment, different models or applications may be assigned different priorities. For example, some models may have a real-time (TAT<1 min) priority while others may have lower priority (e.g., TAT<10 min). In at least one embodiment, model execution times may be measured from requesting institution or entity and may include partner network traversal time, as well as execution on an inference service.

In at least one embodiment, transfer of requests between services 1020 and inference applications may be hidden behind a software development kit (SDK), and robust transport may be provide through a queue. In at least one embodiment, a request will be placed in a queue via an API for an individual application/tenant ID combination and an SDK will pull a request from a queue and give a request to an application. In at least one embodiment, a name of a queue may be provided in an environment from where an SDK will pick it up. In at least one embodiment, asynchronous communication through a queue may be useful as it may allow any instance of an application to pick up work as it becomes available. Results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1126, and an inference service may perform inferencing on a GPU.

In at least one embodiment, visualization service(s) 1120 may be leveraged to generate visualizations for viewing outputs of applications and/or deployment pipeline(s) 1110. In at least one embodiment, GPUs/Graphics 1122 may be leveraged by visualization service(s) 1120 to generate visualizations. In at least one embodiment, rendering effects, such as ray-tracing, may be implemented by visualization service(s) 1120 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1120 may include an internal visualizer, cinematics, and/or other rendering or image processing capabilities or functionality (e.g., ray tracing, rasterization, internal optics, etc.).

In at least one embodiment, hardware 1022 may include GPUs/Graphics 1122, AI system 1124, cloud 1126, and/or any other hardware used for executing training system 1004 and/or deployment system 1006. In at least one embodiment, GPUs/Graphics 1122 (e.g., NVIDIA's TESLA and/or QUADRO GPUs) may include any number of GPUs that may be used for executing processing tasks of compute service(s) 1116, AI service(s) 1118, visualization service(s) 1120, other services, and/or any of features or functionality of software 1018. For example, with respect to AI service(s) 1118, GPUs/Graphics 1122 may be used to perform pre-processing on imaging data (or other data types used by machine learning models), post-processing on outputs of machine learning models, and/or to perform inferencing (e.g., to execute machine learning models). In at least one embodiment, cloud 1126, AI system 1124, and/or other components of system 1100 may use GPUs/Graphics 1122. In at least one embodiment, cloud 1126 may include a GPU-optimized platform for deep learning tasks. In at least one embodiment, AI system 1124 may use GPUs, and cloud 1126—or at least a portion tasked with deep learning or inferencing—may be executed using one or more AI systems 1124. As such, although hardware 1022 is illustrated as discrete components, this is not intended to be limiting, and any components of hardware 1022 may be combined with, or leveraged by, any other components of hardware 1022.

In at least one embodiment, AI system 1124 may include a purpose-built computing system (e.g., a super-computer or an HPC) configured for inferencing, deep learning, machine learning, and/or other artificial intelligence tasks. In at least one embodiment, AI system 1124 (e.g., NVIDIA's DGX) may include GPU-optimized software (e.g., a software stack) that may be executed using a plurality of GPUs/Graphics 1122, in addition to CPUs, RAM, storage, and/or other components, features, or functionality. In at least one embodiment, one or more AI systems 1124 may be implemented in cloud 1126 (e.g., in a datacenter) for performing some or all of AI-based processing tasks of system 1100.

In at least one embodiment, cloud 1126 may include a GPU-accelerated infrastructure (e.g., NVIDIA's NGC) that may provide a GPU-optimized platform for executing processing tasks of system 1100. In at least one embodiment, cloud 1126 may include an AI system 1124 for performing one or more of AI-based tasks of system 1100 (e.g., as a hardware abstraction and scaling platform). In at least one embodiment, cloud 1126 may integrate with application orchestration system 1128 leveraging multiple GPUs to enable seamless scaling and load balancing between and among applications and services 1020. In at least one embodiment, cloud 1126 may tasked with executing at least some of services 1020 of system 1100, including compute service(s) 1116, AI service(s) 1118, and/or visualization service(s) 1120, as described herein. In at least one embodiment, cloud 1126 may perform small and large batch inference (e.g., executing NVIDIA's TENSOR RT), provide an accelerated parallel computing API and platform 1130 (e.g., NVIDIA's CUDA), execute application orchestration system 1128 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1100.

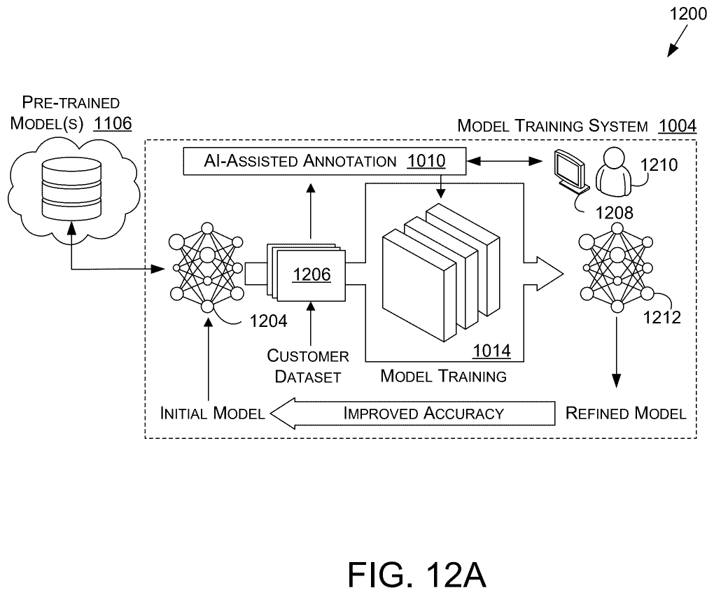

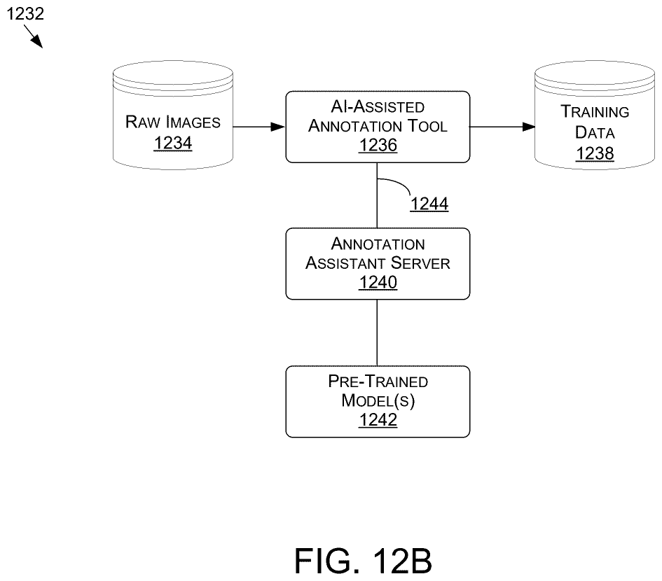

FIG. 12A illustrates a data flow diagram for a process 1200 to train, retrain, or update a machine learning model, in accordance with at least one embodiment. In at least one embodiment, process 1200 may be executed using, as a non-limiting example, system 1100 of FIG. 11. In at least one embodiment, process 1200 may leverage services and/or hardware as described herein. In at least one embodiment, refined models 1212 generated by process 1200 may be executed by a deployment system for one or more containerized applications in deployment pipelines.

In at least one embodiment, model training 1014 may include retraining or updating an initial model 1204 (e.g., a pre-trained model) using new training data (e.g., new input data, such as customer dataset 1206, and/or new ground truth data associated with input data). In at least one embodiment, to retrain, or update, initial model 1204, output or loss layer(s) of initial model 1204 may be reset, deleted, and/or replaced with an updated or new output or loss layer(s). In at least one embodiment, initial model 1204 may have previously fine-tuned parameters (e.g., weights and/or biases) that remain from prior training, so training or retraining 1014 may not take as long or require as much processing as training a model from scratch. In at least one embodiment, during model training 1014, by having reset or replaced output or loss layer(s) of initial model 1204, parameters may be updated and re-tuned for a new data set based on loss calculations associated with accuracy of output or loss layer(s) at generating predictions on new, customer dataset 1206.

In at least one embodiment, pre-trained models 1206 may be stored in a data store, or registry. In at least one embodiment, pre-trained models 1206 may have been trained, at least in part, at one or more facilities other than a facility executing process 1200. In at least one embodiment, to protect privacy and rights of patients, subjects, or clients of different facilities, pre-trained models 1206 may have been trained, on-premise, using customer or patient data generated on-premise. In at least one embodiment, pre-trained models 1106 may be trained using a cloud and/or other hardware, but confidential, privacy protected patient data may not be transferred to, used by, or accessible to any components of a cloud (or other off premise hardware). In at least one embodiment, where pre-trained models 1206 is trained at using patient data from more than one facility, pre-trained models 1206 may have been individually trained for each facility prior to being trained on patient or customer data from another facility. In at least one embodiment, such as where a customer or patient data has been released of privacy concerns (e.g., by waiver, for experimental use, etc.), or where a customer or patient data is included in a public data set, a customer or patient data from any number of facilities may be used to train pre-trained models 1206 on-premise and/or off premise, such as in a datacenter or other cloud computing infrastructure.

In at least one embodiment, when selecting applications for use in deployment pipelines, a user may also select machine learning models to be used for specific applications. In at least one embodiment, a user may not have a model for use, so a user may select a pre-trained model to use with an application. In at least one embodiment, pre-trained model may not be optimized for generating accurate results on customer dataset 1206 of a facility of a user (e.g., based on patient diversity, demographics, types of medical imaging devices used, etc.). In at least one embodiment, prior to deploying a pre-trained model into a deployment pipeline for use with an application(s), pre-trained model may be updated, retrained, and/or fine-tuned for use at a respective facility.

In at least one embodiment, a user may select pre-trained model that is to be updated, retrained, and/or fine-tuned, and this pre-trained model may be referred to as initial model 1204 for a training system within process 1200. In at least one embodiment, a customer dataset 1206 (e.g., imaging data, genomics data, sequencing data, or other data types generated by devices at a facility) may be used to perform model training (which may include, without limitation, transfer learning) on initial model 1204 to generate refined model 1212. In at least one embodiment, ground truth data corresponding to customer dataset 1206 may be generated by training system 1004. In at least one embodiment, ground truth data may be generated, at least in part, by clinicians, scientists, doctors, practitioners, at a facility.

In at least one embodiment, AI-assisted annotation may be used in some examples to generate ground truth data. In at least one embodiment, AI-assisted annotation (e.g., implemented using an AI-assisted annotation SDK) may leverage machine learning models (e.g., neural networks) to generate suggested or predicted ground truth data for a customer dataset. In at least one embodiment, a user may use annotation tools within a user interface (a graphical user interface (GUI)) on a computing device.

In at least one embodiment, user 1210 may interact with a GUI via computing device 1208 to edit or fine-tune (auto)annotations. In at least one embodiment, a polygon editing feature may be used to move vertices of a polygon to more accurate or fine-tuned locations.

In at least one embodiment, once customer dataset 1206 has associated ground truth data, ground truth data (e.g., from AI-assisted annotation, manual labeling, etc.) may be used by during model training to generate refined model 1212. In at least one embodiment, customer dataset 1206 may be applied to initial model 1204 any number of times, and ground truth data may be used to update parameters of initial model 1204 until an acceptable level of accuracy is attained for refined model 1212. In at least one embodiment, once refined model 1212 is generated, refined model 1212 may be deployed within one or more deployment pipelines at a facility for performing one or more processing tasks with respect to medical imaging data.

In at least one embodiment, refined model 1212 may be uploaded to pre-trained models in a model registry to be selected by another facility. In at least one embodiment, this process may be completed at any number of facilities such that refined model 1212 may be further refined on new datasets any number of times to generate a more universal model.

FIG. 12B is an example illustration of a client-server architecture 1232 to enhance annotation tools with pre-trained annotation models, in accordance with at least one embodiment. In at least one embodiment, AI-assisted annotation tool 1236 may be instantiated based on a client-server architecture 1232. In at least one embodiment, AI-assisted annotation tool 1236 in imaging applications may aid radiologists, for example, identify organs and abnormalities. In at least one embodiment, imaging applications may include software tools that help user 1210 to identify, as a non-limiting example, a few extreme points on a particular organ of interest in raw images 1234 (e.g., in a 3D MRI or CT scan) and receive auto-annotated results for all 2D slices of a particular organ. In at least one embodiment, results may be stored in a data store as training data 1238 and used as (for example and without limitation) ground truth data for training. In at least one embodiment, when computing device 1208 sends extreme points for AI-assisted annotation, a deep learning model, for example, may receive this data as input and return inference results of a segmented organ or abnormality. In at least one embodiment, pre-instantiated annotation tools, such as AI-assisted annotation tool 1236 in FIG. 12B, may be enhanced by making API calls (e.g., API Call 1244) to a server, such as an Annotation Assistant Server 1240 that may include a set of pre-trained models 1242 stored in an annotation model registry, for example. In at least one embodiment, an annotation model registry may store pre-trained models 1242 (e.g., machine learning models, such as deep learning models) that are pre-trained to perform AI-assisted annotation on a particular organ or abnormality. These models may be further updated by using training pipelines. In at least one embodiment, pre-installed annotation tools may be improved over time as new labeled data is added.

Various embodiments can be described by the following clauses:
1. A system, comprising:
a coherent fabric including a plurality of processing units logically interconnected, using a plurality of links, to function as a single processing unit with a single combined address space and a coherent interface structure; and
a system manager to manage performance of a job, while the job is running, using the coherent fabric, wherein the system manager is to:
   detect an error in at least one of the processing units or the links;
   logically remove, from the coherent fabric, at least a portion of at least one processing unit or at least one link associated with the error;
   dynamically update the single combined address space; and
   allow the job to continue running using the coherent fabric with the updated address space.
2. The system of clause 1, wherein the error is one of an uncontrollable memory error, an uncorrectable link error, a correctable memory error at least satisfying a memory threshold, or a correctable link error predicted to become an uncorrectable link error.
3. The system of clause 1, wherein the system manager is further to automatically identify and isolate sectors or memory are associated with the error and have been determined to be unreliable to continue the performance of the job.
4. The system of clause 1, wherein the system manager is further to identify sections of a processing resource that are determined to be insufficiently performant and mask off those sections from further use in the performance of the job.
5. The system of clause 1, wherein the system manager is further to identify a location of an uncorrectable error in a frame buffer memory, and mark a page containing the uncorrectable error as unusable in the performance of the job.
6. The system of clause 1, wherein the system manager is further to prevent known degraded memory locations from being used in the performance of the job by remapping other memory locations to avoid exposing one or more affected rows, the system manager further allowed to logically replace degrading memory locations with spare memory locations to avoid offlining regions of memory.
7. The system of clause 1, wherein the system manager includes at least one of a job manager, a fabric manager, or a resource manager.
8. The system of clause 1, wherein the links include a set of high speed links with an ability to use atomic structures and variables with a unified memory map interface.
9. A system comprising one or more processing units to:
logically connect a plurality of processing units as part of a network fabric with a shared memory space; and
during performance of a job using the network fabric:
   detect a slow link associated with an identified processing unit of the plurality; and
   mask the identified processing unit from the network fabric, allowing the performance of the job to continue using a remaining portion of the network fabric without stopping or interrupting the job.
10. The system of clause 9, wherein the one or more processing units are further to, while the job is running:
detect an error in memory of a second identified processing unit; and
mask at least a portion of the memory, associated with the error, from the network fabric, allowing a remaining portion of the network fabric to continue the performance of the job without stopping or restarting the job.
11. The system of clause 10, wherein the one or more processing units are further to: dynamically update an address space associated with the shared memory space to account for masking of the portion of memory.
12. The system of clause 9, wherein a second identified processing unit is to be masked from the network fabric if an available portion of memory in the second identified processing unit falls below a minimum memory threshold.
13. The system of clause 9, wherein the one or more processing units are further to:
insert a sequence of checkpoints in performance of the job; and
in response to an error, restart a portion of the job impacted by the error from a corresponding and most recent checkpoint.
14. The system of clause 9, wherein the one or more processing units are further to:
identify a location of an uncorrectable error in a frame buffer memory, and mark a page containing the uncorrectable error as unusable in the performance of the job.
15. The system of clause 9, wherein the system is at least one of:
a system for testing or validating autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.
16. At least one processor comprising processing circuitry to logically remove, from a coherent fabric of processing units logically interconnected to function as a single processing unit with a single combined address space and a coherent interface structure, at least one of the processing units that is determined to be associated with an error during performance of a job, and to dynamically update the single combined address space to allow the performance of the job to continue uninterrupted using the coherent fabric with the updated address space.
17. The at least one processor of clause 16, wherein the processing circuitry is further to detect an error associated with one or more sections of memory, mask off the one or more sections of memory, and automatically perform remapping of the single combined address space.
18. The at least one processor of clause 16, wherein the processing circuitry is further to:
automatically identify and isolate sectors or memory are associated with the error and have been determined to be unreliable to continue the performance of the job; and
identify sections of a processing resource that are determined to be insufficiently performant and mask off those sections from further use in the performance of the job.
19. The at least one processor of clause 16, wherein the processing circuitry is further to:
insert a sequence of checkpoints in performance of the job; and
in response to the error, restart a portion of the job impacted by the error from a corresponding and most recent checkpoint.
20. The at least one processor of clause 16, wherein at least one processor is contained in:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.

Other variations are within spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of term “set” (e.g., “a set of items”) or “subset” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, term “plurality” indicates a state of being plural (e.g., “a plurality of items” indicates multiple items). In at least one embodiment, number of items in a plurality is at least two, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

In at least one embodiment, an arithmetic logic unit is a set of combinational logic circuitry that takes one or more inputs to produce a result. In at least one embodiment, an arithmetic logic unit is used by a processor to implement mathematical operation such as addition, subtraction, or multiplication. In at least one embodiment, an arithmetic logic unit is used to implement logical operations such as logical AND/OR or XOR. In at least one embodiment, an arithmetic logic unit is stateless, and made from physical switching components such as semiconductor transistors arranged to form logical gates. In at least one embodiment, an arithmetic logic unit may operate internally as a stateful logic circuit with an associated clock. In at least one embodiment, an arithmetic logic unit may be constructed as an asynchronous logic circuit with an internal state not maintained in an associated register set. In at least one embodiment, an arithmetic logic unit is used by a processor to combine operands stored in one or more registers of the processor and produce an output that can be stored by the processor in another register or a memory location.

In at least one embodiment, as a result of processing an instruction retrieved by the processor, the processor presents one or more inputs or operands to an arithmetic logic unit, causing the arithmetic logic unit to produce a result based at least in part on an instruction code provided to inputs of the arithmetic logic unit. In at least one embodiment, the instruction codes provided by the processor to the ALU are based at least in part on the instruction executed by the processor. In at least one embodiment combinational logic in the ALU processes the inputs and produces an output which is placed on a bus within the processor. In at least one embodiment, the processor selects a destination register, memory location, output device, or output storage location on the output bus so that clocking the processor causes the results produced by the ALU to be sent to the desired location.

In the scope of this application, the term arithmetic logic unit, or ALU, is used to refer to any computational logic circuit that processes operands to produce a result. For example, in the present document, the term ALU can refer to a floating point unit, a DSP, a tensor core, a shader core, a coprocessor, or a CPU.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as system may embody one or more methods and methods may be considered a system.

In present document, references may be made to obtaining, acquiring, receiving, or inputting analog or digital data into a subsystem, computer system, or computer-implemented machine. In at least one embodiment, process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example implementations of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

1. A system, comprising:
a coherent fabric including a plurality of processing units logically interconnected, using a plurality of links, to function as a single processing unit with a single combined address space and a coherent interface structure; and
a system manager to manage performance of a job, while the job is running, using the coherent fabric, wherein the system manager is to:
detect an error in at least one of the processing units or the links;
logically remove, from the coherent fabric, at least a portion of at least one processing unit or at least one link associated with the error;
dynamically update the single combined address space to exclude addresses, in the coherent fabric, corresponding to the removed portion; and
allow the job to continue running using a remaining portion of the coherent fabric with the updated address space.

2. The system of claim 1, wherein the error is one of an uncorrectable memory error, an uncorrectable link error, a number or rate of correctable memory errors exceeding a memory threshold, or a correctable link error predicted to become an uncorrectable link error.

3. The system of claim 1, wherein the system manager is further configured to automatically identify and isolate sectors of memory that are associated with the error and have been determined to be unreliable, to continue the performance of the job.

4. The system of claim 1, wherein the system manager is further configured to identify sections of a processing resource that are determined to be less performing than one or more other sections of the processing resource and mask off those sections from further use in the performance of the job.

5. The system of claim 1, wherein the system manager is further configured to identify a location of an uncorrectable error in a frame buffer memory, and mark a page containing the uncorrectable error as unusable in the performance of the job.

6. The system of claim 1, wherein the system manager is further configured to prevent known degraded memory locations from being used in the performance of the job by remapping other memory locations to avoid exposing one or more affected rows, the system manager is further configured to logically replace degrading memory locations with spare memory locations to avoid offlining regions of memory.

7. The system of claim 1, wherein the system manager includes at least one of a job manager, a fabric manager, or a resource manager.

8. The system of claim 1, wherein the links include a set of high speed links with an ability to use atomic structures and variables with a unified memory map interface.

9. A system comprising one or more processing units to:
logically connect a plurality of processing units as part of a network fabric with a shared memory space; and
during performance of a job using the network fabric:
detect a slow link associated with an identified processing unit of the plurality;
mask the identified processing unit from the network fabric;
dynamically update the shared memory space to exclude addresses, in the network fabric, corresponding to the masked processing unit; and
allow the performance of the job to continue using a remaining portion of the network fabric with the updated shared memory space, without stopping or interrupting the job.

10. The system of claim 9, wherein the one or more processing units are further to, while the job is running:
detect an error in memory of a second identified processing unit; and
mask at least a portion of the memory, associated with the error, from the network fabric, allowing a remaining portion of the network fabric to continue the performance of the job without stopping or restarting the job.

11. The system of claim 10, wherein the one or more processing units are further to:
dynamically update an address space associated with the shared memory space to account for masking of the portion of memory.

12. The system of claim 9, wherein a second identified processing unit is to be masked from the network fabric if an available portion of memory in the second identified processing unit falls below a minimum memory threshold.

13. The system of claim 9, wherein the one or more processing units are further to:
insert a sequence of checkpoints in performance of the job; and
in response to an error, restart a portion of the job impacted by the error from a corresponding and most recent checkpoint.

14. The system of claim 9, wherein the one or more processing units are further to:
identify a location of an uncorrectable error in a frame buffer memory, and mark a page containing the uncorrectable error as unusable in the performance of the job.

15. The system of claim 9, wherein the system is at least one of:
a system for testing or validating autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.

16. At least one processor comprising processing circuitry to logically remove, from a coherent fabric of processing units logically interconnected to function as a single processing unit with a single combined address space and a coherent interface structure, at least one of the processing units that is determined to be associated with an error during performance of a job, and to dynamically update the single combined address space to exclude addresses, in the coherent fabric, corresponding to the removed at least one of the processing units, to allow the performance of the job to continue uninterrupted using a remaining portion of the coherent fabric with the updated address space.

17. The at least one processor of claim 16, wherein the processing circuitry is further configured to detect an error associated with one or more sections of memory, mask off the one or more sections of memory, and automatically perform remapping of the single combined address space.

18. The at least one processor of claim 16, wherein the processing circuitry is further configured to:
automatically identify and isolate sectors of memory that are associated with the error and have been determined to be unreliable, to continue the performance of the job; and
identify sections of a processing resource that are determined to be less performant than one or more other sections of the processing resource and mask off those sections from further use in the performance of the job.

19. The at least one processor of claim 16, wherein the processing circuitry is further configured to:
insert a sequence of checkpoints in performance of the job; and
in response to the error, restart a portion of the job impacted by the error from a corresponding and most recent checkpoint.

20. The at least one processor of claim 16, wherein at least one processor is contained in:
a system for performing simulation operations;
a system for performing simulation operations to test or validate autonomous machine applications;
a system for performing digital twin operations;
a system for performing light transport simulation;
a system for rendering graphical output;
a system for performing deep learning operations;
a system for performing generative AI operations using a large language model (LLM);
a system implemented using an edge device;
a system for generating or presenting virtual reality (VR) content;
a system for generating or presenting augmented reality (AR) content;
a system for generating or presenting mixed reality (MR) content;
a system incorporating one or more Virtual Machines (VMs);
a system implemented at least partially in a datacenter;
a system for performing hardware testing using simulation;
a system for performing generative operations using a language model (LM);
a system for synthetic data generation;
a collaborative content creation platform for 3D assets; or
a system implemented at least partially using cloud computing resources.
